(19) United States
(12) Patent Application Publication
(10) Pub. No.: US 2006/0118636 A1
(43) Pub. Date: Jun. 8, 2006

(54) System and method for coordinating movement of personnel

(75) Inventors: Lesley Lucinda Miles, Morgan Hill, CA (US); John Vi Phan, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: PlanReady, Inc.

(21) Appl. No.: 11/296,598

(22) Filed: Dec. 6, 2005

Related U.S. Application Data
(60) Provisional application No. 60/634,429, filed on Dec. 7, 2004.

(51) Int. Cl. G06K 7/10

(52) U.S. Cl. 235/472.01

(57) ABSTRACT

Embodiments of this invention provide a system and method for coordinating movement of personnel. The system includes a portable device, a client device, and a server system. The portable device connects to the client device to present information relating to a physical site of the coordinated movement to a personnel member. When the client device has a network connection, the client device connects to the server system which updates the information stored in the portable device. The information stored in the portable device and the server system are presented to the personnel member via a user interface which includes tools allowing the member to overlay layers on an aerial view of the site, view additional data about features of a site, and collaborate with other personnel.

### CROSS-REFERENCE TO RELATED APPLICATION

This application claims the benefit of, and incorporates by reference in its entirety, provisional Application No. 60/634,429, which was filed on Dec. 7, 2004, titled “Emergency Preparedness and Project Management System and Method.”

### TECHNICAL FIELD

Embodiments of this invention relate to information systems and, in particular, to a system and method for coordinating movement of personnel.

### RELATED ART

Many difficulties arise when attempting to coordinate movement of personnel. These difficulties are especially apparent during time-sensitive scenarios, such as crisis or disasters. To act efficiently and effectively, each personnel member, whether on-site or off-site, must have ready access to certain information. For example, access to a map of the coordinated movement site is often crucial to the success of the operation. Additionally, though not necessary to accomplish a task, certain information allows a personnel member to act more quickly. For example, a firefighter can locate and shut-off a utility more quickly if the firefighter has a photograph of the shut-off valve in its physical surroundings. Furthermore, while certain personnel members must have access to some information, other personnel should not have access to the same information. This may be because the information is irrelevant to the other personnel member's roles and/or responsibilities, for example.

Conventional systems provide some communication devices between personnel members, but these devices typically allow communications between members of the same agency only, e.g. between firefighters but not between a firefighter and a police officer. Additionally, these communication devices are typically audio devices, e.g. radio transceivers, which do not allow the on-site personnel to view information such as aerial views of the site and photographs of features of the site. To communicate this information to on-site personnel, off-site personnel with access to the views often try to describe this information verbally to on-site personnel, which can be inefficient and ineffective. Additionally, these views may be out of date archived versions of the information.

Therefore, what is needed is an improved system and method for coordinating movement of personnel.

### BRIEF DESCRIPTION OF THE DRAWINGS

One or more embodiments of the present invention are illustrated, by way of example and not limitation, in the figures of the accompanying drawings, in which like references indicate similar elements and in which:

FIG. 1 is a block diagram of a network scheme in accordance with one embodiment of this invention;

FIG. 2 is a block diagram of a portable device of FIG. 1 connected to a client device of FIG. 1 in accordance with one embodiment of this invention;

FIG. 3 is a block diagram showing components of the server system of FIG. 1 in accordance with one embodiment of this invention;

FIG. 4 is a flow diagram of interactions between a portable device, a client device, and the server system of FIG. 1 in accordance with one embodiment of this invention;

FIG. 5A is a screenshot of a user interface displayed on a display of a client device of FIG. 1 in accordance with one embodiment of this invention;

FIG. 5B is a screenshot of an online version of the user interface shown in FIG. 5A; and

FIGS. 6A-6D and FIGS. 7A-7M are various screenshots showing various aspects of the user interface shown in FIG. 5A.

FIG. 8 is a screenshot of a user interface displayed on a display of a client device of FIG. 1 in accordance with one application of one embodiment of this invention.

### DETAILED DESCRIPTION

A system and method for coordinating movement of personnel is disclosed. In the following detailed description, numerous specific details are set forth in order to provide a thorough understanding of the present invention. However, it will be apparent to one of ordinary skill in the art that these specific details need not be used to practice the present invention. In other circumstances, well-known structures, materials, or processes have not been shown or described in detail in order to avoid unnecessarily obscuring the present invention.

As used herein, “personnel members” refers to individuals involved in a coordinated movement including both on-site personnel and off-site personnel. In certain applications of this invention, on-site personnel include, for example, local administrative staff, firefighters, police officers, hazardous materials handlers, and other first responders. Off-site personnel often include coordinators located at command centers, expert consultants, and other administrators.

As used herein, a “coordinated movement” refers to a movement of one or more personnel members in a coordinated fashion. A coordinated movement may involve, for example, a movement of emergency personnel during a rescue operation, a disaster mitigation operation, a crisis operation (e.g. Tsunami evacuation), or an anti-terrorist protection operation. A coordinated movement may also include pre-planning movements of individuals, or guiding individual movement, whether or not the individual is moving as part of a group. For example, the coordinated movement may guide individual first responders through a site in case of smoke by looking at plans and/or pictures of surroundings through which someone is guided. A coordinated movement often involves time sensitive activities with costly and potentially fatal consequences. The personnel members involved in the movement typically have specific roles, responsibilities, knowledge, skills, and training. Certain roles and/or responsibilities depend on the location and scope of the operation. For example, if the movement is a rescue operation during a flood, certain personnel members may be involved only when the extent of the operation reaches a critical scope, spans several localities, or involves a certain jurisdiction. Therefore, more and more personnel may become involved in the movement over a potentially short period of time.

As used herein, a “physical site” refers to a physical location of a coordinated movement through which personnel move. The physical site may be, for example, a school, a building, a corporate campus, or a city.

The following provides variations and examples of various aspects of embodiments of the invention. It will be appreciated that the following variations and examples are not intended to be exhaustive or to limit the invention to the precise forms disclosed. These variations and examples are to provide further understanding of embodiments of the present invention.

Architecture

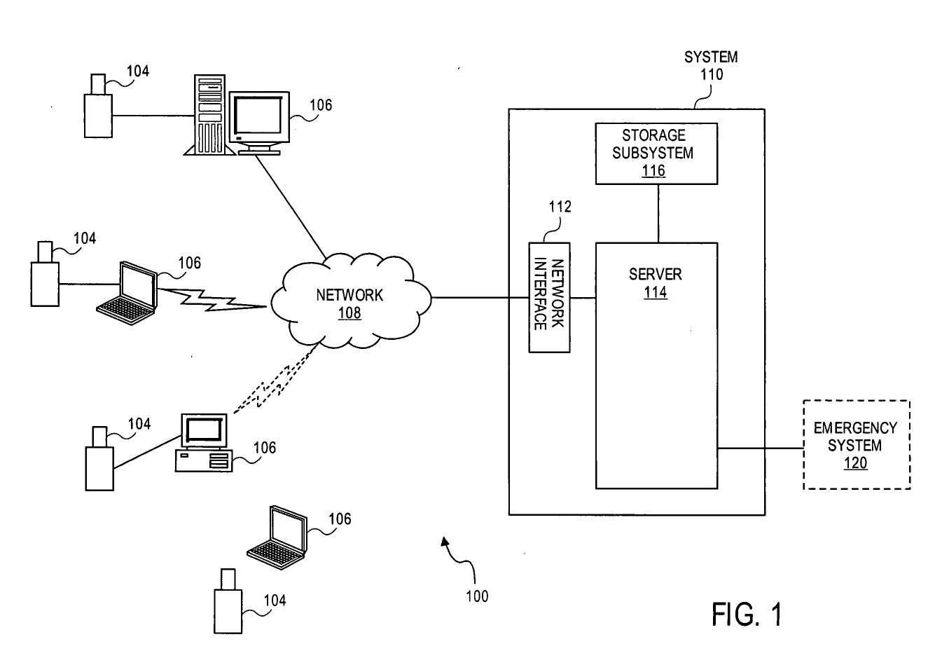

FIG. 1 is a block diagram of a network scheme in accordance with one embodiment of this invention. In FIG. 1, a network scheme 100 includes portable devices 104, client devices 106, a network 108, a server system 110, and an optional emergency system 120.

A portable device 104 is a device having a local memory and an output interface to communicate with a client device 106. In one exemplary embodiment, a portable device 104 is a universal serial bus (USB) memory stick having a memory and a USB connector to plug into a USB port in a client device, e.g. a laptop. The portable device 104 may also be, for example, a personal digital assistant (PDA) or a mobile phone. The portable devices 106 also include any portable devices that can be mounted as a drive on a client device. In one embodiment, the portable device 104 can connect to a client device 106. In one exemplary application, each on-site personnel member is assigned a portable device 104 to have available during a coordinated movement. In one embodiment, the portable device is the client device, e.g. in a personal digital assistant (PDA).

A client device 106 is a device having an input interface to receive input from a portable device 104, a processor to execute instructions stored in the portable device 104, and an input/output (I/O) port to communicate information to and from a personnel member using the client device 106. A client device 106 may be, for example, a desktop computer, a laptop, or a PDA. Certain client devices 106 connect to the network 108 to access information available from a server system 110, also connected to the network 108.

In operation, a personnel member connects a portable device 104 to a client device 106 during a coordinated movement in order to view information stored in the portable device relevant to the movement. The information may be, for example, a site plan of the physical site of the movement, e.g. a school. In certain applications, the client device 106 is a computer at the site, e.g. a computer in a school office.

The network 108 is a network through which a client device 106 communicates with a server system 110. The network 108 may encompass several subnetworks and may include wireless and/or landline communications systems, e.g. local area networks (LANs), wide area networks (WANs), virtual private networks (VPNs), or the Internet.

The server system 110 is a system which includes a network interface 112, a server 114, and a storage subsystem 116. The network interface 112 is an interface through which a portable device 104, via a client device 106, communicates with the server. The network interface 112 includes a network interface card (NIC) to receive and transmit communications using, in one exemplary embodiment, transmission control protocol/internet protocol (TCP/IP) and hypertext transfer protocol (HTTP).

The server 114 provides access to information stored in the storage subsystem 116. In one embodiment, when a portable device 104 connected to a client device 106 has a network connection to the server 114, the server 114 updates a version of information stored in the portable device. For example, in one application, after a personnel member connects a portable device 104 to a client device 106, the personnel member runs an executable stored on the portable device 104 on the client device 106. Using the executable, the member views on a client device display (e.g. a monitor) an aerial photograph of a school where flood victims are reported to be stranded, for example. The photograph shows a version of the school prior to the flooding. When the client device obtains a network connection to the server 114, the server 114 updates the information stored in the portable device to provide the member with current information about the school, including a recent aerial photograph the school after the flooding. Using this information, the on-site personnel member is able to control the site to find the victims more easily.

In one embodiment, the system tracks revisions and changes to a site, e.g. new plans, contacts, or documents. These revisions may include, for example, aerial photos of the flood site described above. In one embodiment, the system allows a member to view a before-flood photo, archived in the system, and compare it continually updated aerial photos of the site during the flood. In one embodiment, the latest photo is displayed as a new layer overlaid on the before-flood photo or site plan. In one embodiment, the latest photos are only provided to certain members with privileges to view the photos, e.g. for security reasons.

In one embodiment, the server 114 updates information stored in a portable device based on a member logged into the device. For example, in one embodiment, if a portable device 104 is shared among different members of a team, the server 114 may update the device depending on which member is logged in.

In another embodiment, the server 114 updates information stored in a portable device based on whether available updated information is relevant to the individual or group assigned to the device. For example, if a site contains information for multiple schools and a fire department is only responsible for a subset of the schools, the information updated on the portable device assigned to the fire department is updated with only the information relevant to their jurisdiction.

In certain embodiments, updates to portable devices are executed on a per request basis. For example, when information regarding a site is requested, the information is updated after a server connection is available. This configuration is beneficial when a small number of portable devices are managed by the system because it minimizes download and updated times.

In other embodiments, updates to portable devices are executed as the updated information becomes available, rather than on a per request basis. This configuration is beneficial when a large number of portable devices are managed by the system and tracking and synchronizing information may become a bottleneck in system performance.

In one embodiment, the portable device 104 is located on-site in a secured container, e.g. a Knox-Box® available from Knox Company. For example, the secured contained may be located near an emergency entrance or inside a building. A personnel member, e.g. a first responder, may then retrieve the portable device 104 from the secured container during an emergency and, if appropriate, connect the portable device to a client device.

In one embodiment, the secured container includes an interface to the network 108. The portable device 104 may be connected to the interface while stored in the secured container. This configuration enables the information stored in the portable device 104 to be updated with the latest information stored on the server 110 whenever appropriate. Accordingly, a personnel member retrieving the portable device (e.g. during an emergency) may be assured that the portable device stored in the secured container contains up-to-date information.

In one exemplary application, the server 114 includes a web server which provides online web access to the information stored in storage subsystem 116. A member can log into a web portal to retrieve information about the site from the web server, rather than logging in through an executable stored on a portable device 104. For example, an off-site crisis coordinator can log into the server system 110 through the web portal to view the same information an on-site first responder views using a portable device 104 connected to a client device 106. This allows the crisis coordinator to better coordinate the personnel movement, e.g. the flood victim rescue effort discussed above. In certain applications, the crisis coordinator can collaborate with the on-site personnel using a collaboration tool, described below.

The storage subsystem 116 includes one or more nonvolatile storage devices to store information relating to physical site(s) of coordinated movement(s). In one embodiment, the storage subsystem stores member verification information, e.g. usernames and passwords.

In FIG. 1, in one embodiment, the network scheme 100 also includes an optional emergency system 120 connected to the server system 110. The emergency system 120 may be, for example, a fire alarm system or an emergency exit lighting system. When the server system 110 is connected to the emergency system 120, an authorized personnel member logged into the system 110 can send commands to the emergency system. For example, in one application, a crisis coordinator sends a command to turn on and off certain emergency exit lights at a site to re-direct individuals at the site to certain locations. In another application, the emergency system 120 includes video cameras at the site. Using the server system 110, a member can send a command (e.g. by selecting a camera icon overlaid on a site plan) to turn on a particular camera and receive a video stream.

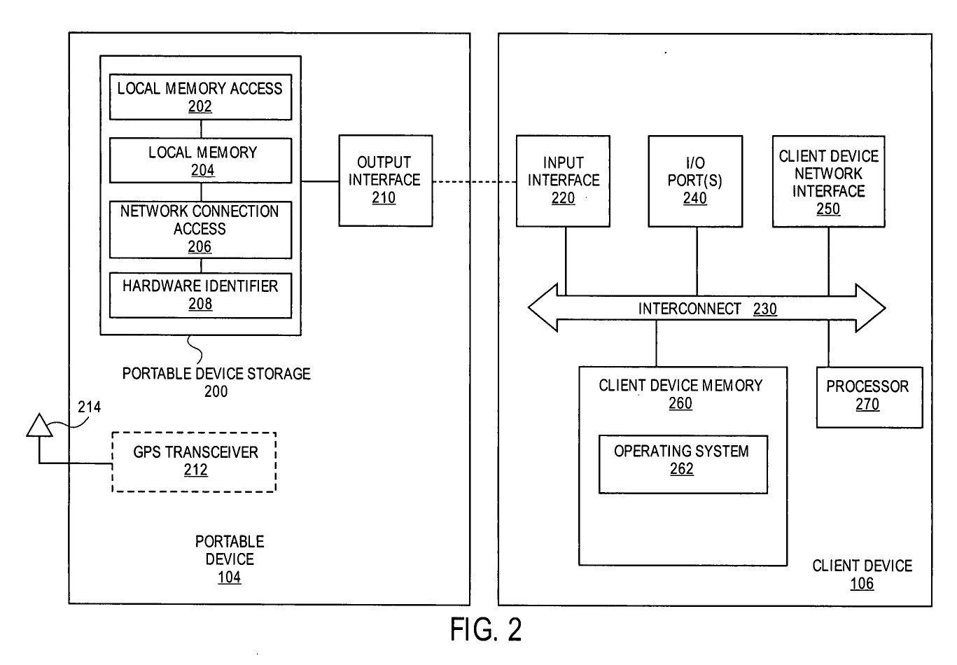

FIG. 2 is a block diagram of a portable device of FIG. 1 connected to a client device of FIG. 1 in accordance with one embodiment of this invention. In FIG. 2, the portable device 104 includes a portable device storage 200, an output interface 210, and an optional global positioning system (GPS) transceiver 212 connected to an optional antenna 214. The client device 106 includes an input interface 220, an interconnect 230, input/output (I/O) port(s) 240, a client device network interface 250, a client device memory 260, and a processor 270.

The portable device storage 200 includes a local memory access 202, a local memory 204, a network connection access 206, and a hardware identifier 208.

The local memory access 202 is connected to the local memory 204 and provides access to information stored in the local memory 204, e.g. the aerial photograph discussed above. In certain applications, the information stored in the local memory 204 includes voice or video instructions on how to operate the portable device, e.g. in conjunction with the client device. This allows a member new to the technology to learn how to operate the device without prearranged training. In one embodiment, instructions of other types, e.g. how to find a fire extinguisher may be included.

Access to the local memory 204 is independent of network access to the server 114. In other words, a personnel member can access the information stored in the local memory 204 regardless of a network connection. This arrangement is especially useful in situations when network access is unavailable or intermittent, such as when the site of the coordinated movement is remote or when infrastructure that provided the network access is compromised, e.g. during a disaster.

The local memory 204 includes nonvolatile memory storing, in one embodiment, a version of the information stored in the server. The version stored in the local memory 204 is based on a role of the personnel member assigned to the portable device. For example, in one application, a portable device assigned to a firefighter includes a map indicating the locations of fire hydrants while a portable device assigned to a police office does not include such a map. In certain applications, the version stored in the local memory 204 may be further based on a profile of the personnel member. For example, a portable device assigned to a fire fighter specially trained to handle a hazardous material may not include handling instructions for that material while other portable devices assigned firefighters not trained to deal with the hazardous material may include such instructions. In another embodiment, all devices have the same data, and each role is actuated based on a selection by the user.

In certain embodiments, the information stored in local memory 204 is independent of the role of the personnel member, but the information that is presented is based on the role of the personnel member. For example, all information related to a site may be stored in a local memory 204, but, based on a member log-in, the most important information relevant to the logged in member, and/or a predetermined format for displaying that information, is be displayed. In certain configurations, access to certain data is limited based on member log-in.

Also connected to the local memory 204 is the network connection access 206. The network connection access 204 communicates with the server 114 to update the version of the information stored in the local memory 204 when the client device 106 has a network connection.

In one embodiment, the portable device includes a hardware identifier 208. In one embodiment, the hardware identifier 208 is unique to the portable device. For example, the hardware identifier may be a media access card (MAC) address. In other embodiments, the portable device may additionally or alternatively include a software identifier, e.g. a certificate or a one-time password (OTP). The following description describes in further detail the application of hardware identifiers in the embodiments of present invention by way of illustration, rather than limitation.

When the portable device 104 includes a hardware identifier 208, the network connection access 206 uses the hardware identifier 208 to securely communicate with the server 114. For example, in one application, the hardware identifier is used to encrypt communications between the portable device/client device and the server.

The hardware identifier 208 may also be used to verify a member's login into the system. For example, when each personnel member (e.g. each firefighter and police officer) is assigned a portable device having a unique hardware identifier, the portable device's hardware identifier value may be submitted along with a username and password when the member logs into the system 110. Submission of the hardware identifier value is typically transparent to the member. The server 114 verifiers that the username, password, and hardware identifier value correspond to expected values stored in the storage subsystem 116. This ensures that the member is logging into the system 110 using the assigned portable device 104. By using the hardware identifier 208 as an added login security measure, an unauthorized individual who somehow discovers a valid username and password will still have difficulties accessing the server 114 without having a corresponding assigned portable device 104. Additionally, an individual who finds a misplaced portable device will have difficulties accessing the server 114 without the corresponding username and password.

In one embodiment, the portable device 104 also includes an output interface 210. The output interface 210 is connected to the portable device storage 200. The output interface 210 allows the portable device 104 to communicate with a client device 106. For example, the output interface allows the portable device to transfer information stored in the storage 200 to the client device 106 for display to a personnel member. For example, the output interface 210 may include a USB connector to connect the portable device 104 to a USB port in the client device 106. The output interface 210 may also include software to ensure that the communications to and from the client device are in accordance with a certain protocol. As shown in FIG. 2, the output interface communicates to the client device 106 via the client device's input interface 220. In one embodiment, the portable device 104 may have an integrated output interface, e.g. an IPOD, such that the portable device is able to use its own screen to display information alternatively or in addition to being able to use a display on the client device.

In one embodiment, the input interface 220 includes a USB port to receive a USB connector of the portable device 104. The input interface 220 is connected to other components of the client device via interconnect 230.

Interconnect 230 interconnects the input interface 220, I/O port(s) 240, client device network interface 250, client device memory 260, and processor 270. In one exemplary embodiment, the interconnect 230 includes one or more buses through which data and command signals are transmitted.

In one embodiment, the I/O port(s) 240 include ports through which a personnel member interacts with the client device. For example, the I/O port(s) 240 may include a port to a display, e.g. a monitor on a computer or a display screen on a PDA or cell phone. The display displays a user interface presenting to the member the aerial photograph discussed above, for example. The I/O port(s) 240 also includes a port to a user input device, e.g. a mouse or keyboard, through which the member may select icons and/or use tools provided via the user interface.

Also interconnected to the interconnect 230 is the client device network interface 250. The client device network interface 250 allows the client device 106 to establish and maintain a network connection to the server 114. The client device network interface 250 includes, in one embodiment, one or more network connections which allow the client device to communicate with networking devices (e.g. routers) in the network 108 of FIG. 1. In certain configurations, the client device network interface 250 includes both an Ethernet connection and a wireless connection. In certain applications, the client device network interface 250 continually attempts to discover network access in order to establish a connection with the server. For example, in operation, a wireless connection in the client device network interface 250 continually attempts to discover a wireless network with which to connect the client device to the server.

Also coupled to the interconnect 230 is the client device memory 260. The client device memory 260 is volatile and/or nonvolatile memory in the client device which stores instructions, e.g. operating system 262. These instructions are executed on the client device using the processor 270. The processor 270 may be, for example, a central processing unit (CPU).

In operation, the processor 270 in a client device runs an executable stored in the portable device's local memory 204. This executable provides access to the information stored in the local memory 204, e.g. the aerial photograph, emergency data, etc. Because the executable is stored the portable device 104, the personnel member does not have to install a software program in the client device 106 to view the information stored in the portable device. In certain applications, the executable includes an image reader to display images stored in the portable device 104.

Storing the executable in the portable device is particularly beneficial when a personnel member does not have the time to install and/or troubleshoot an installation on a client device during a coordinated movement. Additionally, storing the executable on the portable device is also beneficial when the client device is a computer located at the site, e.g. the computer in the school office mentioned above. In such circumstances, the personnel member may not know the configurations and/or operating system of the client device until the coordinated movement is in progress and time is of the essence.

In FIG. 2, in one embodiment, the portable device 104 also includes a global positioning system (GPS) transceiver 212 connected to an antenna 214. In use, the GPS transceiver 212 in the portable device 104 allows the position of the portable device (as well as other portable devices) to be displayed on, for example, a site plan of the physical site of the movement. This arrangement allows both on-site and off-site authorized personnel to determine the location of personnel at the site during the coordinated movement. In other embodiments, a different locator may be used, e.g. locators typically found in mobile phones.

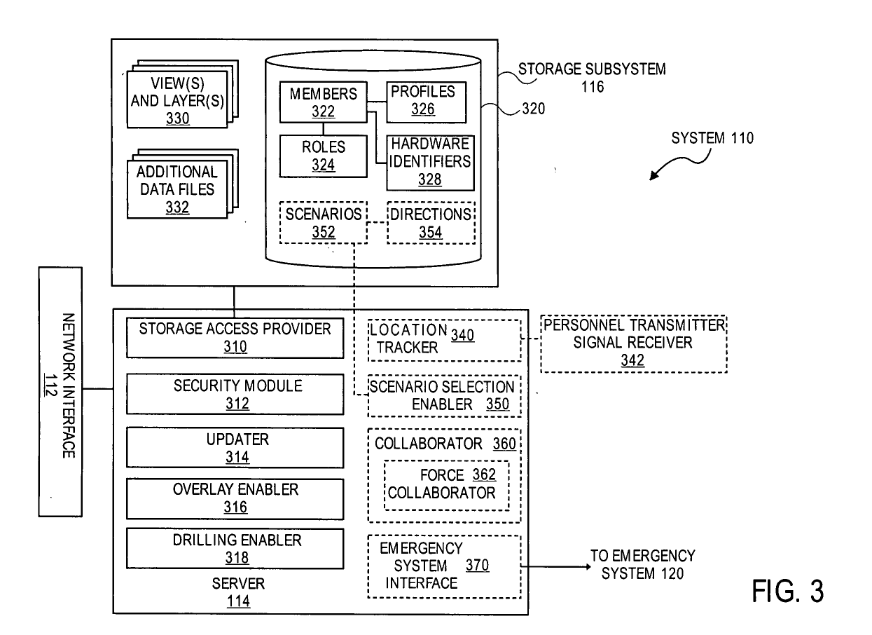

FIG. 3 is a block diagram showing the components of the server system of FIG. 1 in accordance with one embodiment of this invention. In FIG. 3, the server system 110 includes the network interface 112, the server 114, the storage subsystem 116, and an optional personnel transmitter signal receiver 342.

Storage subsystem 116 includes a database 320, view(s) and layer(s) 330, and additional data files 332. The database 320 includes a members table 322, a roles table 324, a profiles table 326, and a hardware identifiers table 328. The members table 322 is linked to the profiles table 326, the roles table 324, and the hardware identifiers table 328 to map relationships between members, roles, profiles, and hardware identifiers. In FIG. 3, the database 320 also includes optional scenarios table 352 and directions table 354.

The server 114 includes a storage access provider 310, a security module 312, an updater 314, an overlay enabler 316, and a drilling enabler 318. The server 114 also includes an optional location tracker 340, scenario selection enabler 350, collaborator 360, and emergency system interface 370.

In operation, a member logs into the system 110 via a portable device 104 connected to a client device 106 or via the web portable discussed above. To log into the system 110, the member submits a username and password to the system 110, for example. The username and password is received at the network interface 112. The security module 312 uses the members table 322 to verify the username and password. In applications in which a hardware identifier value is also submitted, the security module 312 uses the hardware identifier table 328 to further verify the log-in before giving the member access to the information stored in the storage subsystem 116.

After the member is logged into the system 110, the storage access provider 310 provides the member with access to the information in the storage subsystem 116, e.g. the view(s) and layer(s) 330 and the additional data files 332.

The view(s) and layer(s) 330 include views of the physical site of the movement, including an aerial view of the site, e.g. an aerial photograph or a site plan. The server 114 may transmit one or more of these view(s) and layer(s) to a plurality of displays viewed by a plurality of personnel members. These view(s) and layer(s) are presented to the member on the user interface displayed on the respective display as discussed above and seen in the screenshots discussed below. In an exemplary application, the user interface includes shortcuts to certain view based on a member's role and/or profile.

The view(s) and layer(s) 330 also include layers which can be overlaid on the views. In certain exemplary embodiments, the layers are transparent or semi-transparent layers that are placed over a view to emphasize a predetermined category of site features relevant to the role of the member provided with the view.

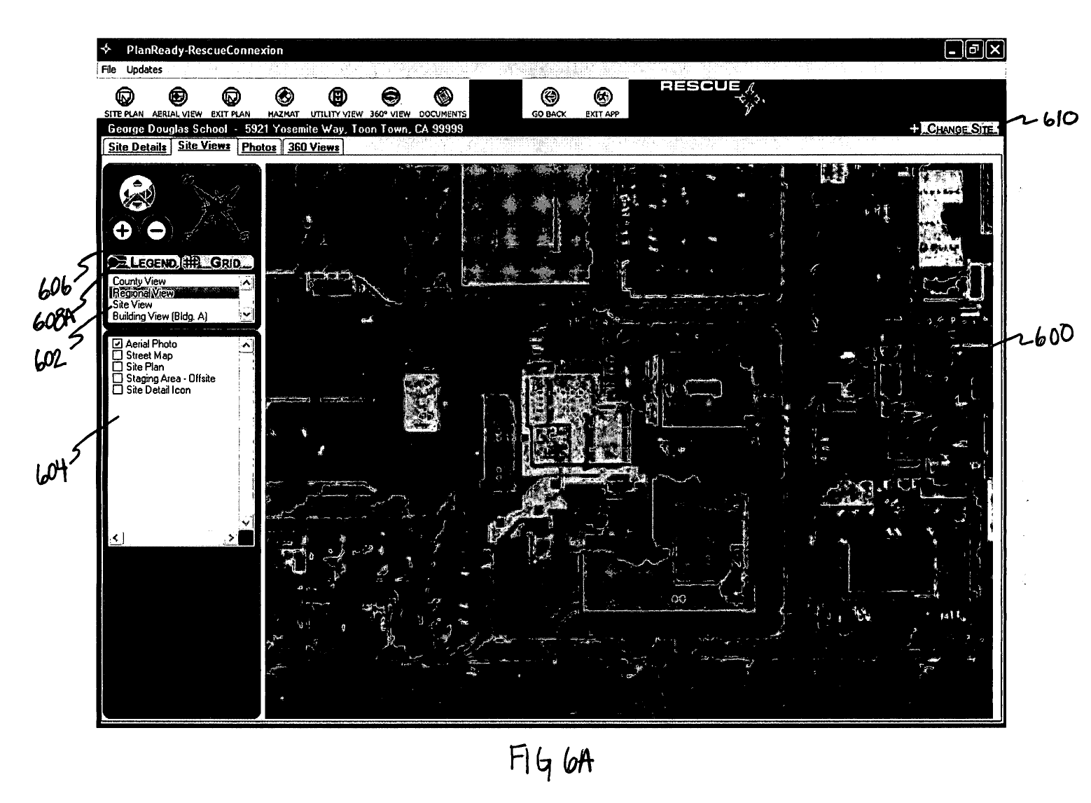

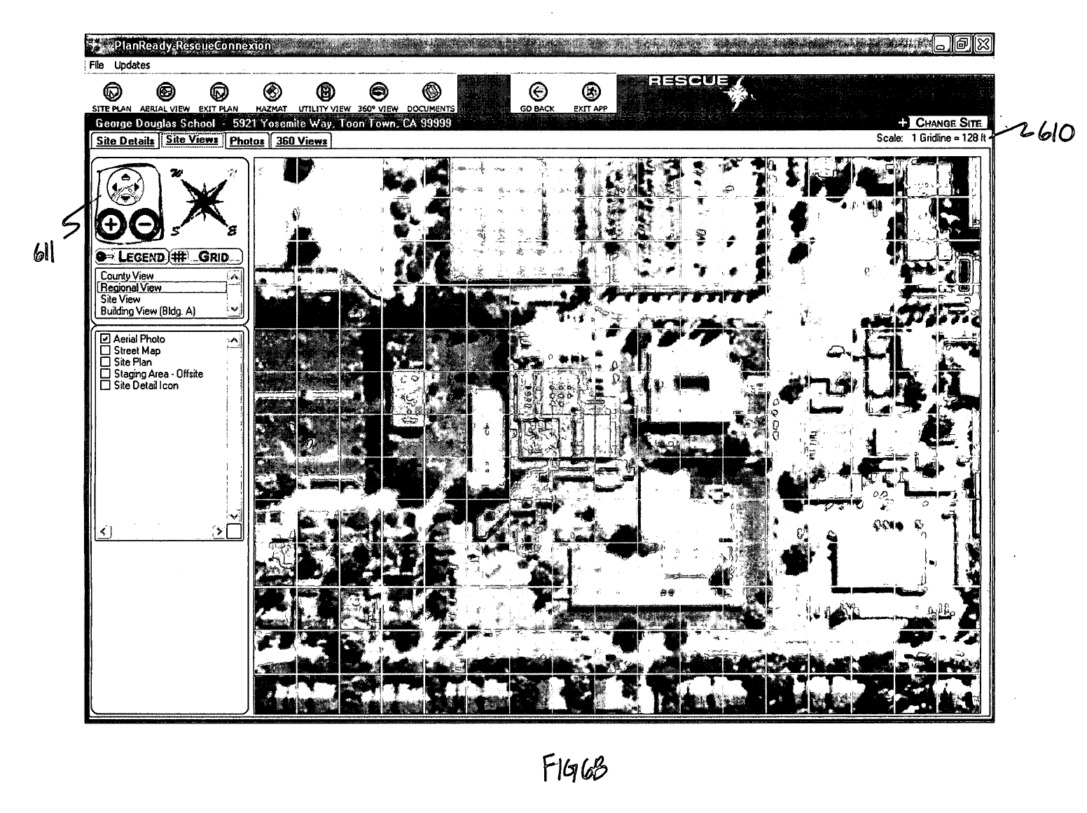

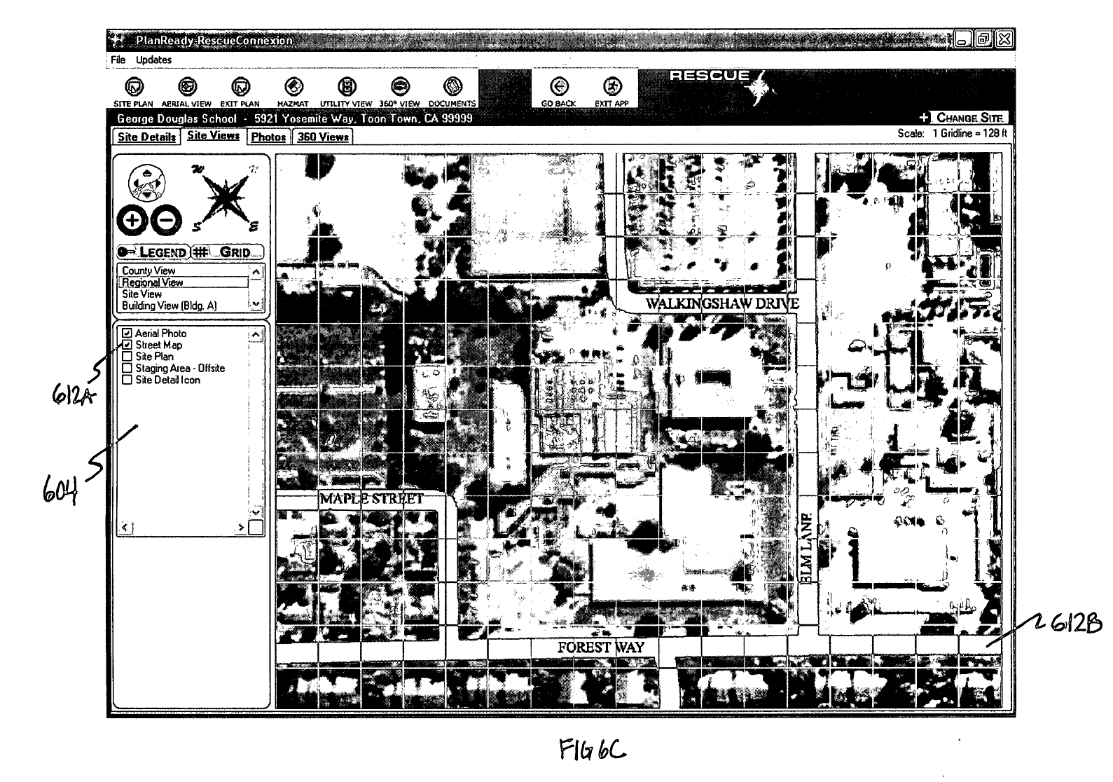

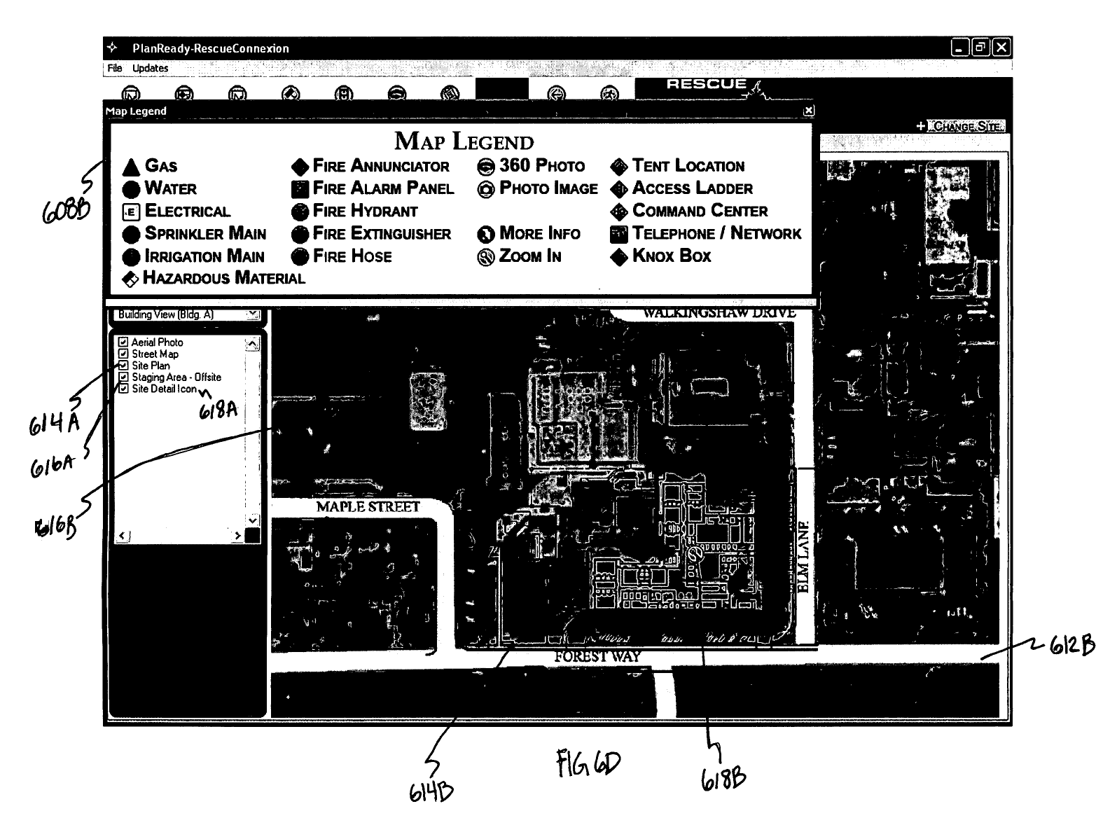

For example, using overlay enabler 316, a layer emphasizing streets may be overlaid on an aerial photograph of a site, e.g. seen in FIG. 6C. This ability is particularly useful in flood emergencies. For example, a stranded victim may identify their location to rescue personnel using street addresses. However, during a flood, streets signs may be under water and the rescue personnel may not know the area well enough to be able to quickly locate the victim without the knowledge of local residents. Using a recent aerial photograph of the flooded region provided by the server 114 and a street map layer overlaid on the aerial view by overlay enabler 316, a rescue personnel member can more quickly locate the stranded victim. Additionally, the rescue personnel member can determine the quickest route to traverse the waterways to reach the victim.

In certain embodiments, one or more layers maybe overlaid on a view automatically based on a profile of the member provided with the view. For example, in one application, the overlay enabler 316 accesses the profiles table 326 when a member logs into the system 110 to determine whether to automatically overlay a layer on the view. The profile may indicate a layer to automatically overlay on the view based on a customized configuration. For example, the member may configure the system to automatically overlay street maps on a view when the member first logs in. The profile may also indicate a layer to automatically overlay on the view based on the member's role, e.g. a layer showing the locations of fire hydrants when the member has a firefighter role. In an exemplary embodiment, overlay enabler 316 also enables the overlaying of a grid on the view to indicate physical distances at the site.

In FIG. 3, the server 114 also includes an updater 314. The updater 314 updates the version of the information stored in a portable device 104 when the corresponding member logs into the system using the portable device, rather than online through a web portal. When a hardware identifier value is available, the updater 314 uses the hardware identifier value to determine the appropriate update to transmit to the portable device. The updater 314 may also use the members table 322, the roles table 324, and/or the profiles table 326 to determine the appropriate information to transmit to and update the portable device.

While a portable device 104 is being updated, the member is still able to view information related to the physical site whether stored in the portable device or received directly or recently from the server. For example, the member can use the overlay enabler 316 to overlay layers of a view while the portable device is being updated.

The member is also able to use tools available through the user interface to retrieve specific information about the site. For example, the member may use a tool to select a site feature emphasized in an overlaid layer to view additional data about the selected site feature.

The selected feature may be, for example, a street, a fire lane, an emergency exit, a staging area, an escape route, and a room. When the member selects the feature, additional data about the feature is displayed on the user interface, e.g. a photo, a pre-recorded video, a live video feed, a detailed drawing, a detailed map, and an architectural plan. When the selected feature is a utility shutoff, a fire hydrant, or hazardous material storage, the additional data may include a description of a location of the feature, operating instructions, shut-off instructions, removal instructions, handling instructions, a photo of the feature, a video of the location of the feature, and contact information for an organization associated with the feature.

In certain configurations, the tool includes an icon positioned in the overlaid layer by an authorized user, e.g. as an administrator or architect. The icon links to a file 332 containing the additional data to be displayed in another overlaid layer when the icon is selected. For example, when a member clicks on an icon located on a site plan to emphasize the location of a fire hydrant, a picture of the fire hydrant may be displayed.

In certain configurations, the tool includes a drill-down tool and a drill-up tool. The drill-down tool enables the member to view increasingly detailed data about the selected site feature and the drill-up tool enables the member to view decreasingly detailed data about the selected site feature.

In FIG. 3, the system 110 also includes a personnel transmitter signal receiver 342 connected to the location tracker 340. In certain embodiments, the personnel transmitter signal receiver includes a GPS transceiver and coupled antenna. In operation, the signal receiver 342 receives signals indicating the locations of personnel at the site. These signals are transmitted to the location tracker 340. Location tracker 340 provides a live feed (or regular updates) of the location of personnel to members logged into the system. Accordingly, the locations of the personnel members may be based on real-time data. In one configuration, the location tracker 340 displays the locations using in a layer overlaid on an aerial view of the site, e.g. an aerial photograph or site plan. The locations may be represented in the layer using colored dots, images, or icons, for example.

In one embodiment, the location tracker provides a layer indicating anticipated locations of people at the site, whether or not personnel members. The anticipated locations are based on independently obtained data. For example, the anticipated locations may be based on an estimated number of people at the site during certain hours (e.g. a number of students during school hours) and a predetermined evacuation route. In another application, the anticipated locations are based on infrared satellite images of the site. Accordingly, the locations may be determined based on real-time data.

In one embodiment, the location of a person or object at the site is indicated on a layer using an icon added to the layer from a personnel member. For example, when an on-site personnel member communicates to an off-site personnel member intelligence about the site (e.g. the location of victims, resistance, or weapons), the off-site personnel member may place an icon indicating the person or object at the site. The icon links to information about the person or object. The linked information may be, for example, a photo, a detailed map, a detailed plan, and/or a video. The icon is seen in the user interfaces of each member logged into the site, based on the member's role. When another personnel member selects the icon, the linked information is displayed to the other member.

In FIG. 3, the server 114 also includes scenario selection enabler 350 connected to the scenarios table 352 and the directions table 354. In operation, the user interface displayed to a personnel member includes a plurality of icons, some of which are associated with corresponding predefined scenarios, e.g. predefined in scenarios table 352. The scenario selection enabler 350 allows a member to use a selector to select an icon associated with a predefined scenario. The selector may include hardware and/or software, e.g. a cursor, a button, or a mouse. Selecting an icon associated with a scenario triggers transmission of directions related to the scenario stored in the directions table 354. These directions are transmitted to at least one other personnel member to direct the receiving member to perform a predetermined action at the site. In one embodiment, the icon dragged and dropped onto a view to trigger various actions, including transmission of the directions and/or opening of a chat or call to certain personnel member.

For example, in operation, predefined scenarios may include various predicted disasters at a certain site. When the particular disaster occurs, e.g. breach of a levee, a crisis coordinator logged onto the system can selects an icon associated with the scenario. This selection triggers directions to be sent to firefighter, police officers, paramedics, and construction engineers, for example, each of whom are logged onto the system. The directions direct these personnel where to direct their rescue and repair efforts, for example. This configuration allows efficient coordination of personnel movement during predictable disasters.

In FIG. 3, the server 114 also includes a collaborator 360 which includes a force collaborator module 362. The collaborator 360 enables personnel members to communicate in real-time using a collaborator tool in the user interface. In certain applications, the collaborator 360 includes instructions and protocols which allow a personnel member to instant message, white board, chat, use a collaborative log book, video conference, and/or phone conference one or more other personnel members. Using the collaboration tool, a member can locate a specific emergency on a view and point it out to the rest of the team that is viewing the map.

The force collaborator module 362 forces a specific view to be displayed simultaneously on each client device having network access to the server and running the executable stored on the respective connected portable device. In operation, a crisis coordinator can use the force collaborator module 362 to force, for example, a zoomed in view of a certain region of the site to provide specific movement instructions related to the region. In certain applications, the view may also be related to a specific scenario.

In FIG. 3, the server 114 also includes an emergency system interface 370 connected to an emergency system 120. The emergency system interface 370 transmits commands to emergency devices in an emergency system at the physical site. For example, as suggested above, the commands may turn on/off emergency exit signs at the site to direct people at the site to certain locations. In certain application, the emergency devices may include an emergency exit sign, an emergency exit direction light, a security camera, a fire door, or a fire sprinkler.

Process

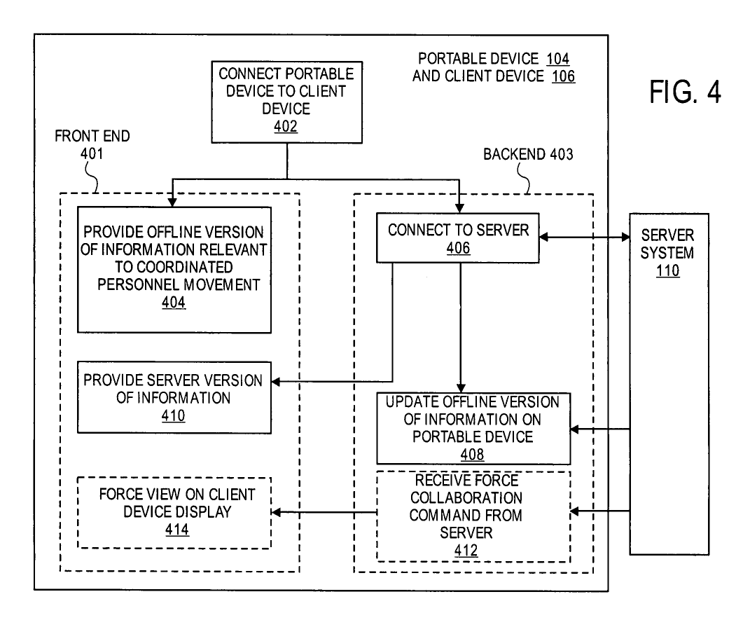

FIG. 4 is a flow diagram of interactions between a portable device, a client device, and the server system of FIG. 1 in accordance with one embodiment of this invention. At 402, a personnel member connects the portable device 104 to the client device 106. For example, when the portable device is a USB memory stick, the personnel member may connect a USB connector portion of the stick into a USB port in the client device 106, e.g. one of I/O port(s) 240 in FIG. 2.

After the portable device 104 is connected to the client device 106, the process continues at both a front end 401 and a backend 403. The front end 401 includes operations apparent to the personnel member, e.g. displaying a user interface to the personnel member. The backend 403 includes operations transparent to the personnel member, e.g. background processes.

In the front end, at 404, the portable device-client device combination provides an offline version of information relevant to the coordinated personnel movement. This offline version of information is stored in local memory 204 of the portable device. This offline version includes, for example, site plans for the physical site (e.g. a school) last uploaded into the portable device. Providing this offline version allows the personnel member to have access to relevant information even when the client device 106 does not have a network connection.

While the personnel member is provided with the offline version of the information at 404, the backend 403 connects to the server at 406. For example, the client device 106 may continually attempt to detect a viable wireless network signal to connect to the server 114 while the personnel member views the offline version of the data. The personnel member may be aware of the backend attempts to connect to the server, but the attempts are executed in a manner which does not distract or affect the activity of the member, e.g. via a separate thread. In one embodiment, the member may cancel or disable server connection functionality, e.g. to reduce the potential of compromising security.

Once connected to the server, the portable device-client device combination at 408 updates the offline version of the information using the online version of the information available via the server 114. For example, if the offline version of the information contains a view of the school prior to a recent remodeling project, the backend may update the view to show the school after the remodeling project was completed.

At 410, the front end provides the personnel with a server version of the information. Accordingly, as network connection is established, on-site personnel are able to obtain the most recent information relating to the coordinated movement.

In certain applications, when a coordinator of the movement wants some or all of the personnel involved in the movement to view the same information, the coordinator directs server 114 to force collaboration between the various devices connected to the server. For example, if firefighters and police officers are all viewing various views of a school, the coordinator may use the force collaborator 362 in the server 114 to force all the firefighters and police officers to view the same view, e.g. a view of the library. Backend 403 receives a force collaboration command from the server at 412. In response, the front end 401 forces a view on a display of the client device at 414.

In one embodiment, a portable device includes hardware and/or software enabling the device to communicate with other portable devices, e.g. in a peer-to-peer fashion. When a server is not available, a portable device can connect to one or more other portable devices and obtain relevant updated information stored on the other portable devices. Accordingly, a portable device in embodiments of this invention may communicate using both wired and/or wireless networking protocols, including Bluetooth protocols, infrared communications protocols, satellite communication protocols, and the like.

In embodiments in which peer-to-peer communication is enabled, the system may include a remote tracker which acts as a centralized server which tracks locations of each portable device. This tracking information may be broadcast (e.g. from a satellite) to one or more mobile command centers. Other information may also be broadcasted to a mobile command center, e.g. availability of portable devices.

In one embodiment, the system keeps a log of which members enter and exit a site, e.g. via GPS locators or electronic gates at the site. This information is relayed to a coordinator (whether on-site or off-site), e.g. a firefighter captain to allow the captain to determine which one of his/her team members has not exited the site. This count information may be updated in the system until the last member has left the site.

In one embodiment, the portable device includes hardware and/or software enabling information from a dispatch system to be displayed on a display of a client device. For example, the portable device may include instructions stored in a local memory which causes a processor in the client device to present a pop-up on a display when a fire station receives an emergency call, or when a police officer responds to a call. The pop-up may contain a message, such as, for example, “Additional RC data available for site.”

Screenshots

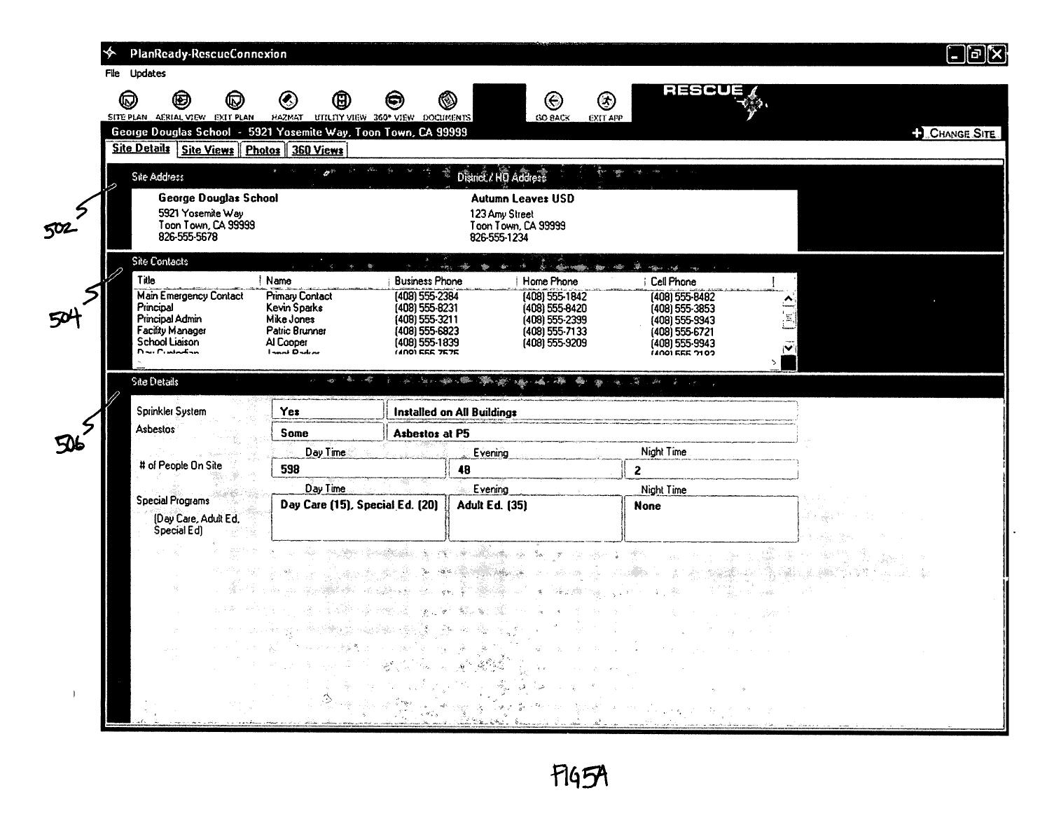

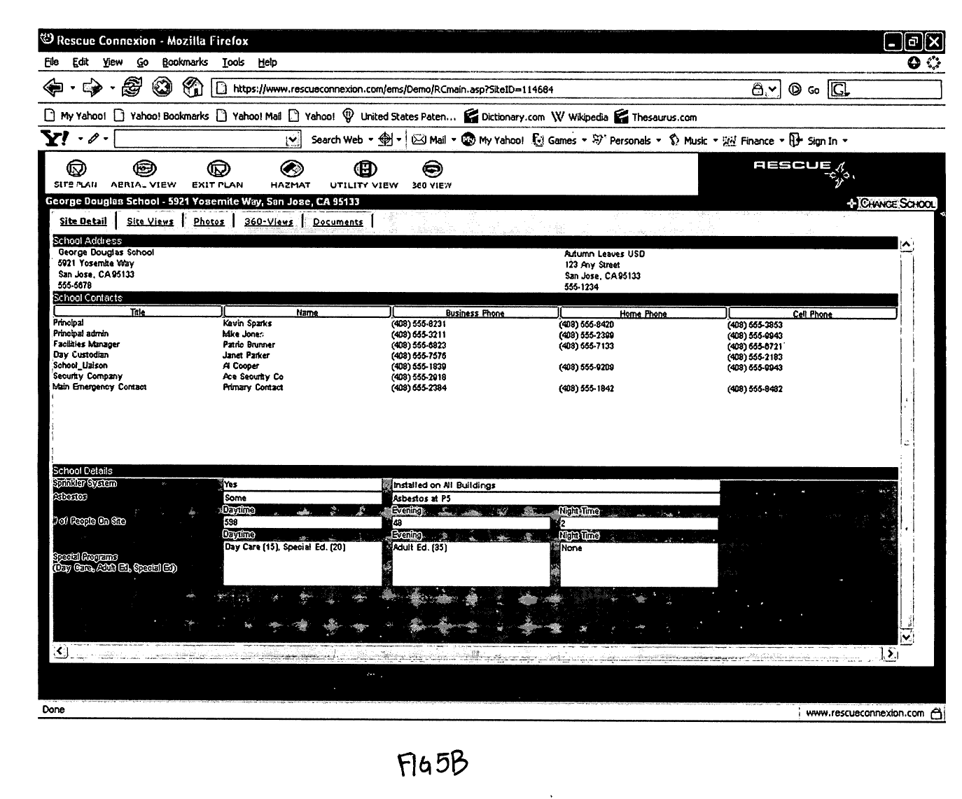

FIG. 5A is a screenshot of a user interface displayed on a display of a client device of FIG. 1 in accordance with one embodiment of this invention. In particular, FIG. 5A is a screenshot of part of an offline version of information stored in a portable device. In FIG. 5A, the user interface includes site address section 502, site contacts section 504, and site details section 506.

Site address section 502 provides a postal address of the site as well as a postal address of a facility where people with jurisdiction over the site are located.

Site contacts section 504 provides names, titles, and phone numbers of individuals with jurisdiction over the physical site. This section allows the personnel member involved in the coordinated movement to have ready access contact information without having to search through an address book.

Site details section 506 provides information particular to the site which may be relevant to the movement. For example, in FIG. 5A, site details section lists the member of people expected to be at the school during certain times of the day. This allows the personnel member to ascertain more accurately the scenario into which he/she will be entering. For example, during the daytime, a fireman will know that he should be expecting to deal with approximately 600 people, 15 of whom may be very young children and 20 of whom may need special assistance in an evacuation.

FIG. 5B is a screenshot of an online version of the user interface shown in FIG. 5A. The online version of the user interface provides the server version of the information that the portable device-client device combination receives after connecting to the server 114. In one exemplary application, the online version is a web application accessible using an Internet browser, e.g. a web portal.

FIG. 6A is a screenshot of another aspect of the user interface shown in FIG. 5A. FIG. 6A includes an aerial view 600 of the site, a view selection menu 602, an overlay selection menu 604, a grid activation tool 606, a legend activation tool 608A, and a change site tool 610.

The aerial view 600 is an aerial photo of the site. As used herein, the term “aerial view” includes any view showing a site from above, e.g. an aerial photo or an architectural site plan.

The view selection menu 602 provides a listing of various aerial views available for the personnel member to see. The views listed in the view selection menu 602 depend on the available views for the physical site stored storage subsystem 116. Different physical sites (selectable using change site tool 610) may have different views available for viewing.

The overlay selection menu 604 provides a listing of various layers that may be overlaid on a view, e.g. aerial view 600. In certain configurations, the layers listed in overlay selection menu 604 differ depending on the role of the personnel member accessing the information.

The grid activation tool 606 allows the personnel member to overlay a grid on a view (e.g. the view 600), as will be discussed in more detail below.

The legend activation tool 608A allows the personnel member to easily determine the meaning of symbols (e.g. icons) overlaid in the view 600, as will be discussed in more detail below.

The change site tool 610 allows the personnel member to change the site shown. For example, if the coordinated movement involves multiple sites, or if the personnel is responsible for responding to emergencies at multiple sites, the personnel member will be able to select which site to view using the change site tool 610. Accordingly, the sites available for viewing through the change site tool 610 differ depending on the individual profile of the member, including the role assigned to the member.

FIG. 6B is a screenshot of the view of FIG. 6A with a grid overlaid on the view after selection of the grid activation tool 606. The grid indicates physical distances at the site. Scale indicator 610 provides a conversion between grid distances and physical distances at the site. This conversion changes as the member zooms in and out of the view using zoom tool 611. The grid permits personnel members to estimate how long it will take to move from location to location at the site and to and from the site.

FIG. 6C is a screenshot of the view of FIG. 6B with a street map layer overlaid on the view. In FIG. 6C, the street map layer listing 612A in the overlay selection menu 604 is selected, thereby indicating that the street map layer 612B is overlaid on the view. In certain applications, the street map layer 612B can help a personnel member determine a route to and/or from the site, e.g. in the flood scenario discussed above wherein the street signs are underwater.

FIG. 6D is a screenshot of the view of FIG. 6A with several layers overlaid on the view. In FIG. 6D, the grid shown in FIG. 6C is not displayed. However, the street map layer 612B shown in FIG. 6C is displayed. Additionally, in FIG. 6D, the site plan layer listing 614A, the stage area layer listing 616A, and the site detail icon layer listing 618A are selected. Accordingly, the site plan layer 614B, the stage area layer 616B, and the site detail icon layer 618B are overlaid on the view.

The meaning of the site detail icon 618B is easily determined using legend 608B, which is displayed when the legend activation tool 608A is selected. As discussed above, in certain applications, selection of an icon provides the personnel member with additional data about the selected feature emphasized using the icon. For example, when a personnel member selects the “SA” icon located over the staging area region, additional information may be displayed to the member, e.g. in a pop-up window.

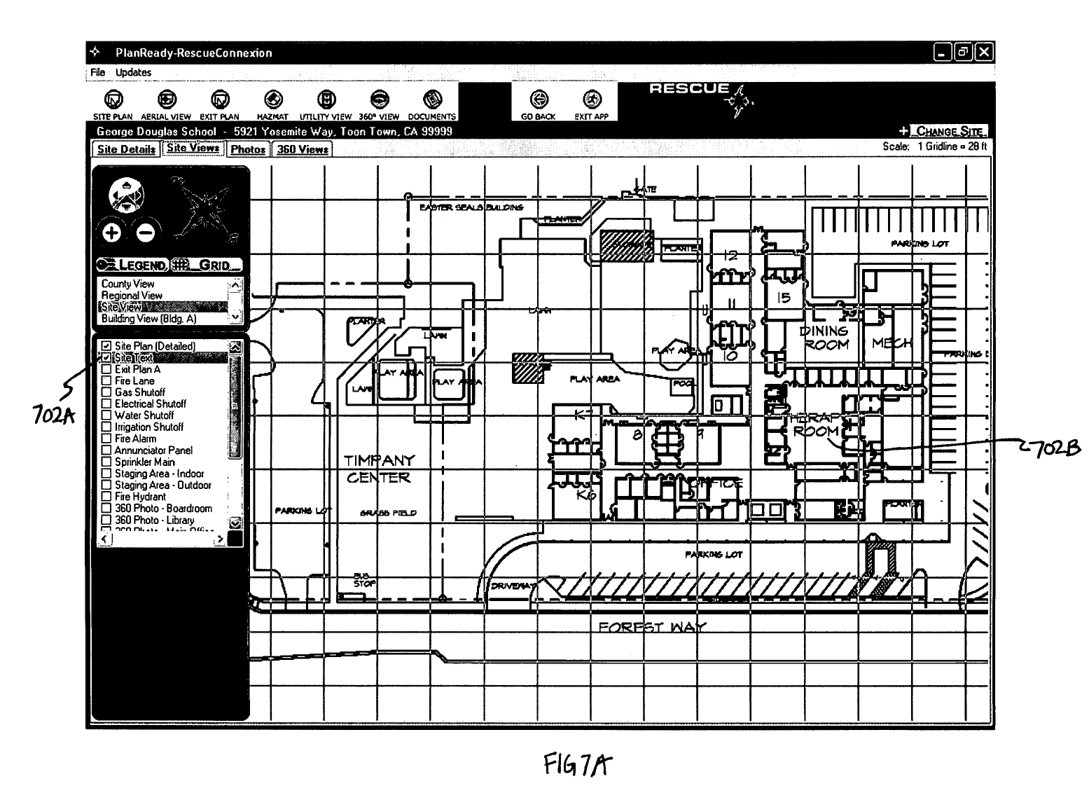

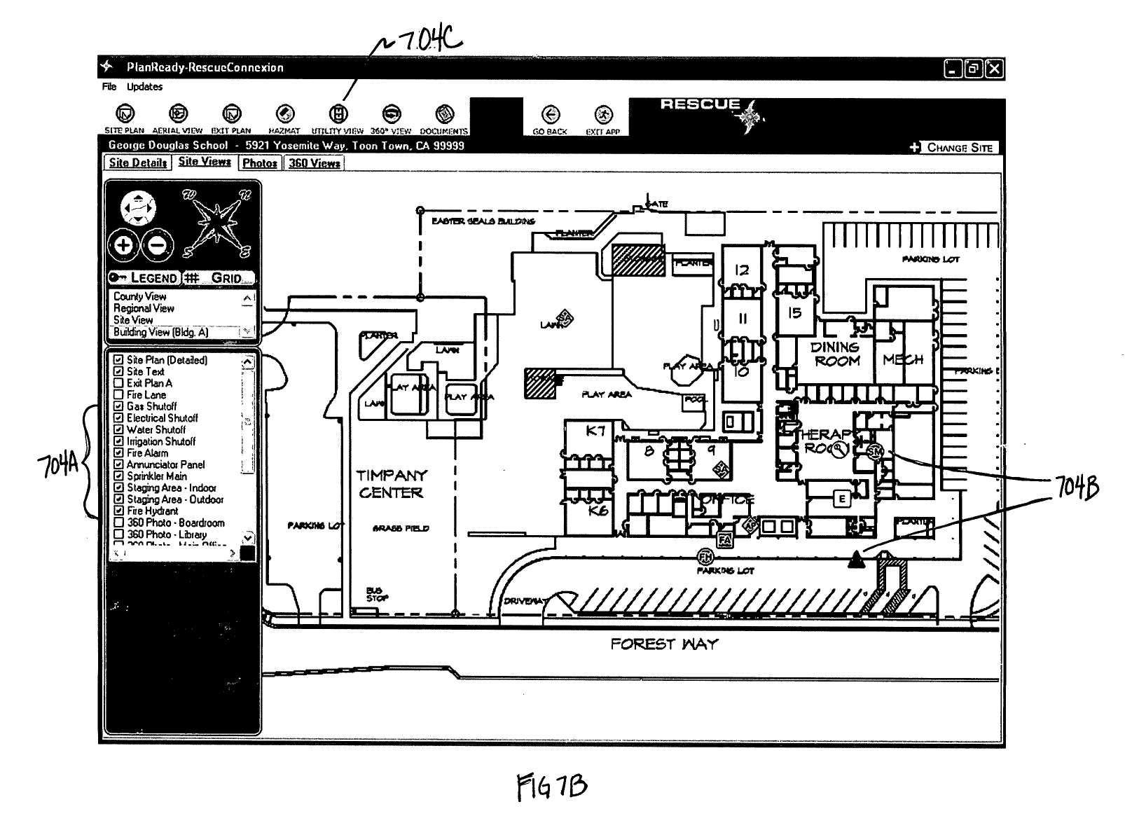

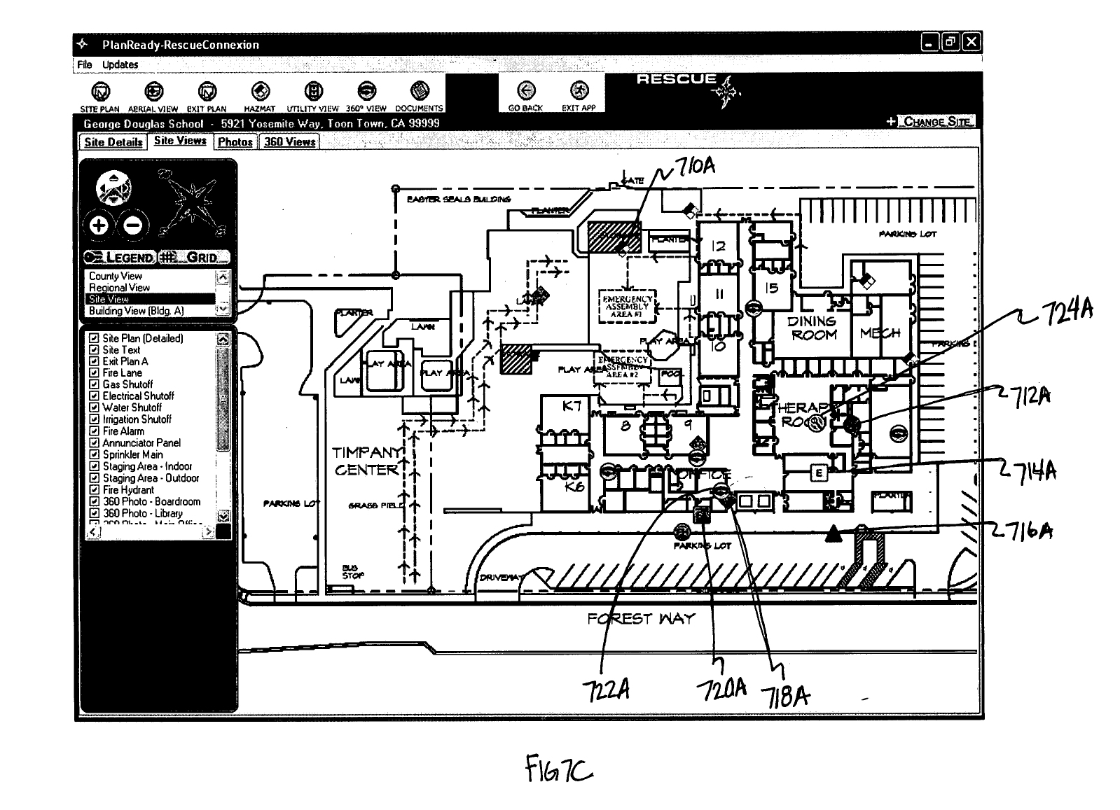

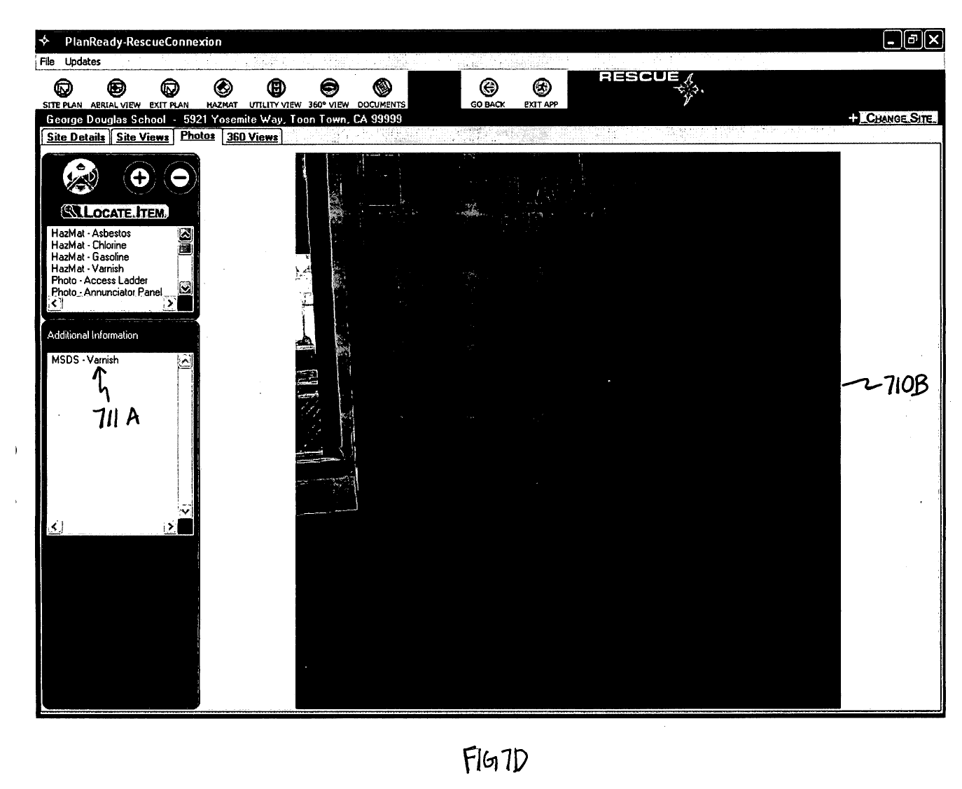

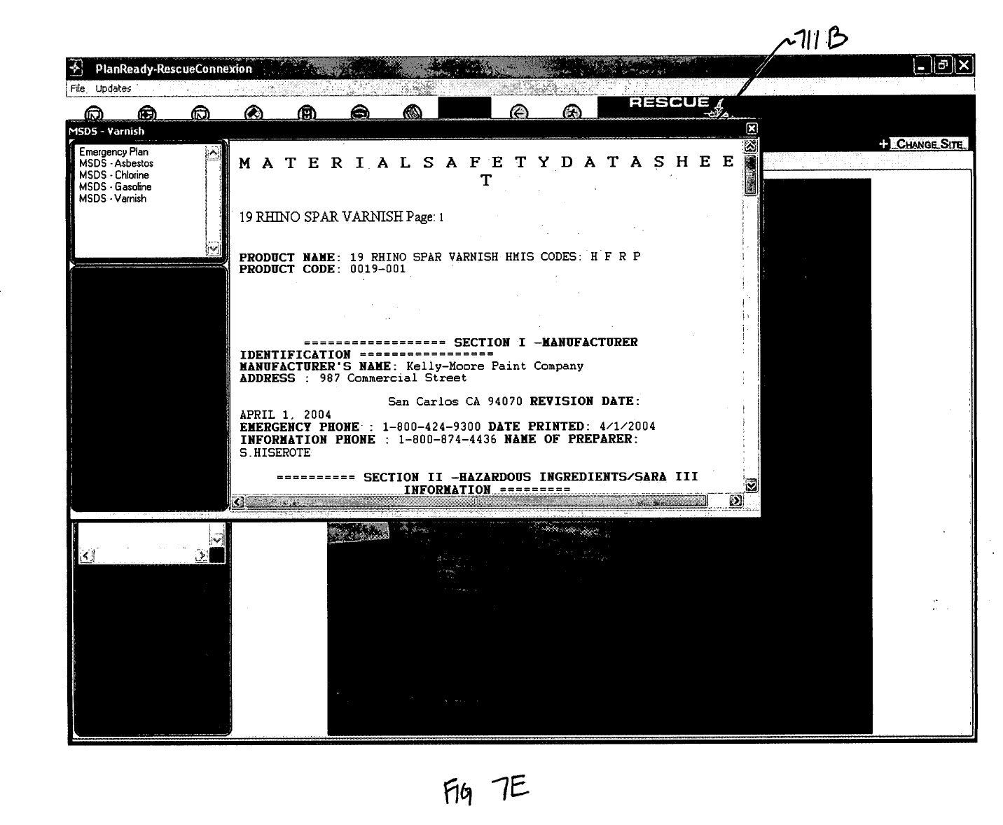

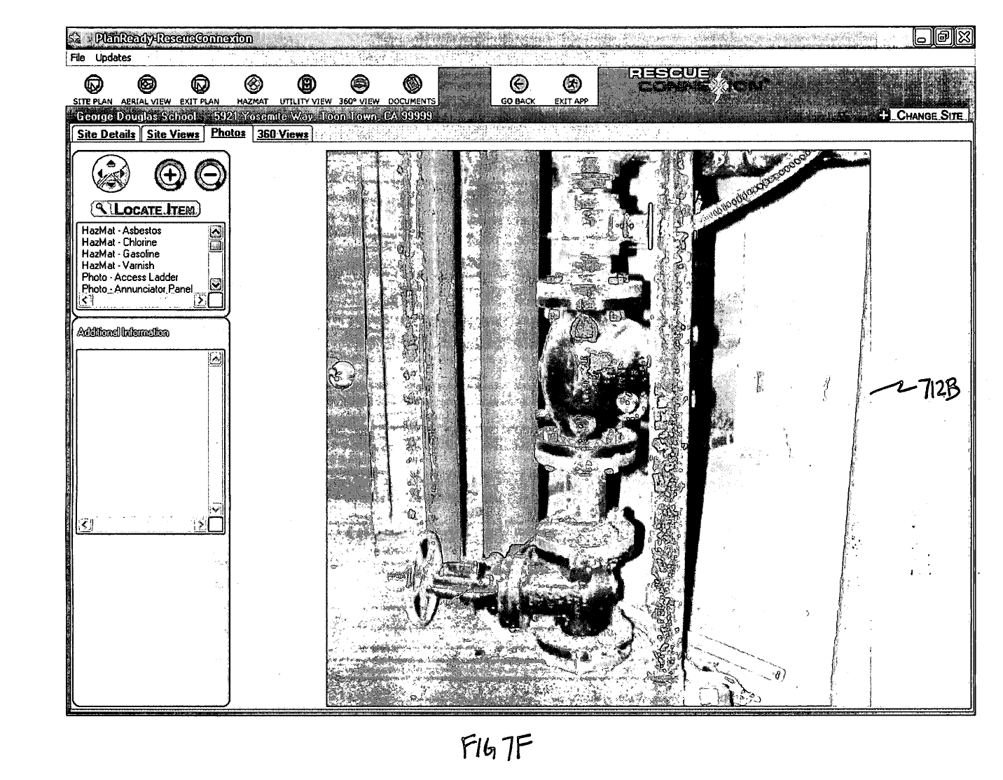

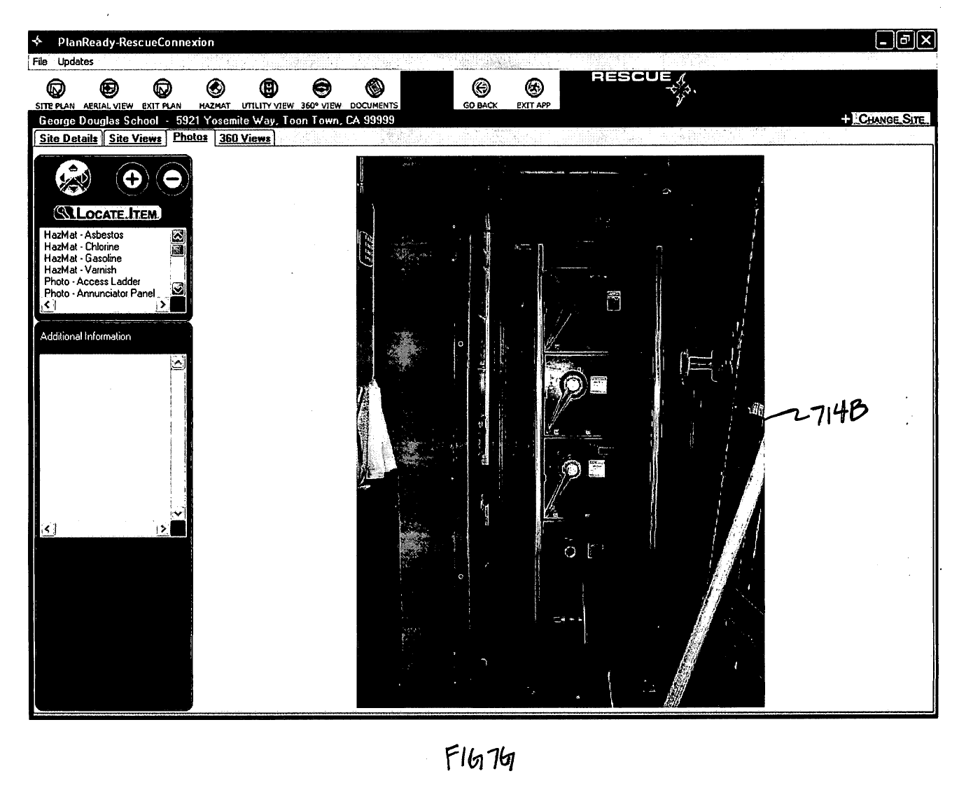

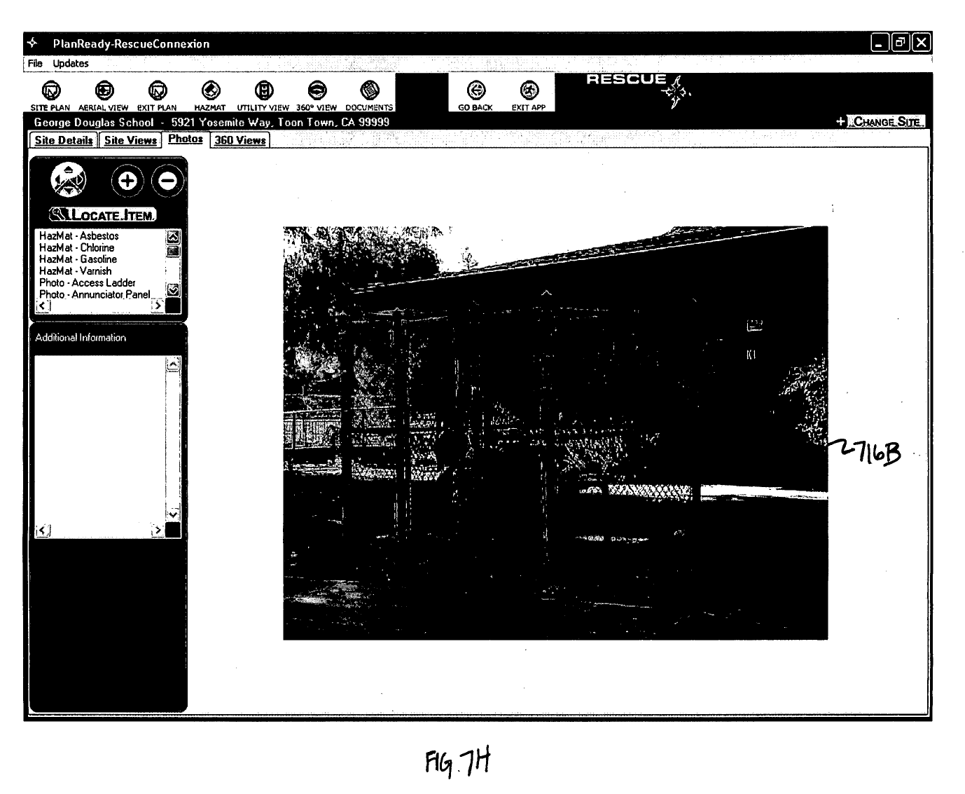

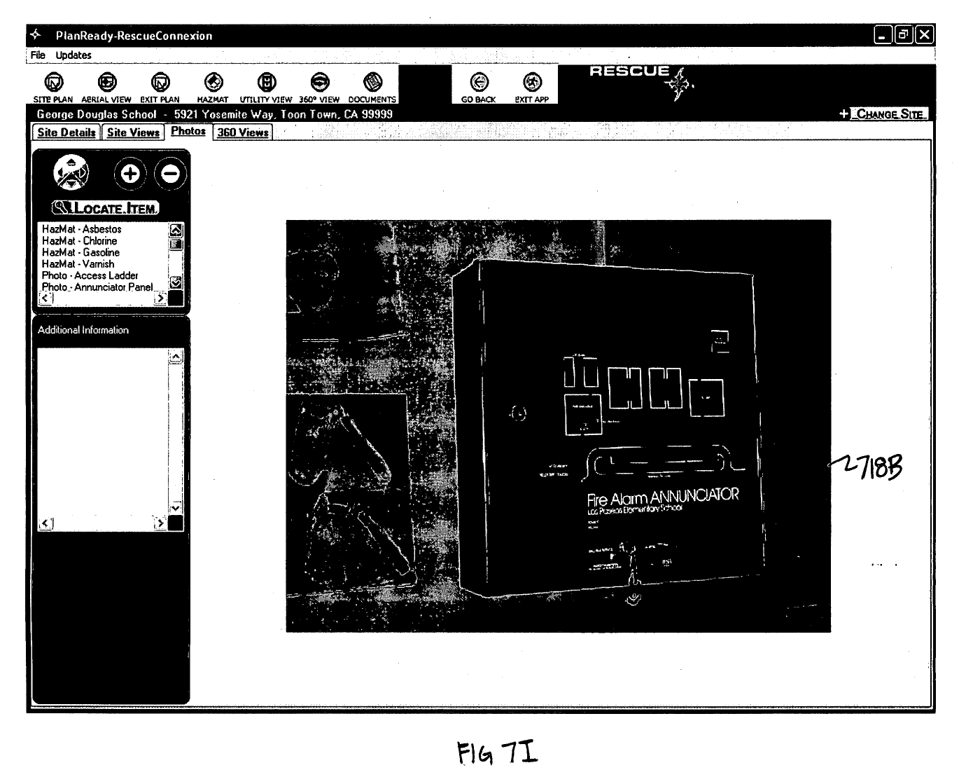

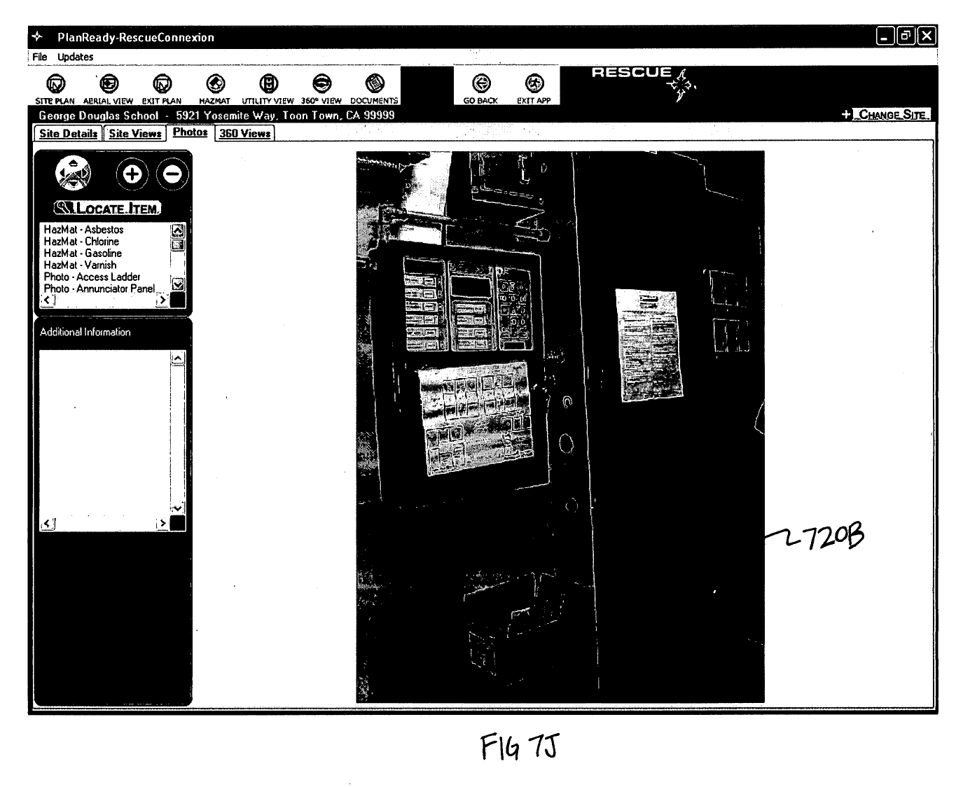

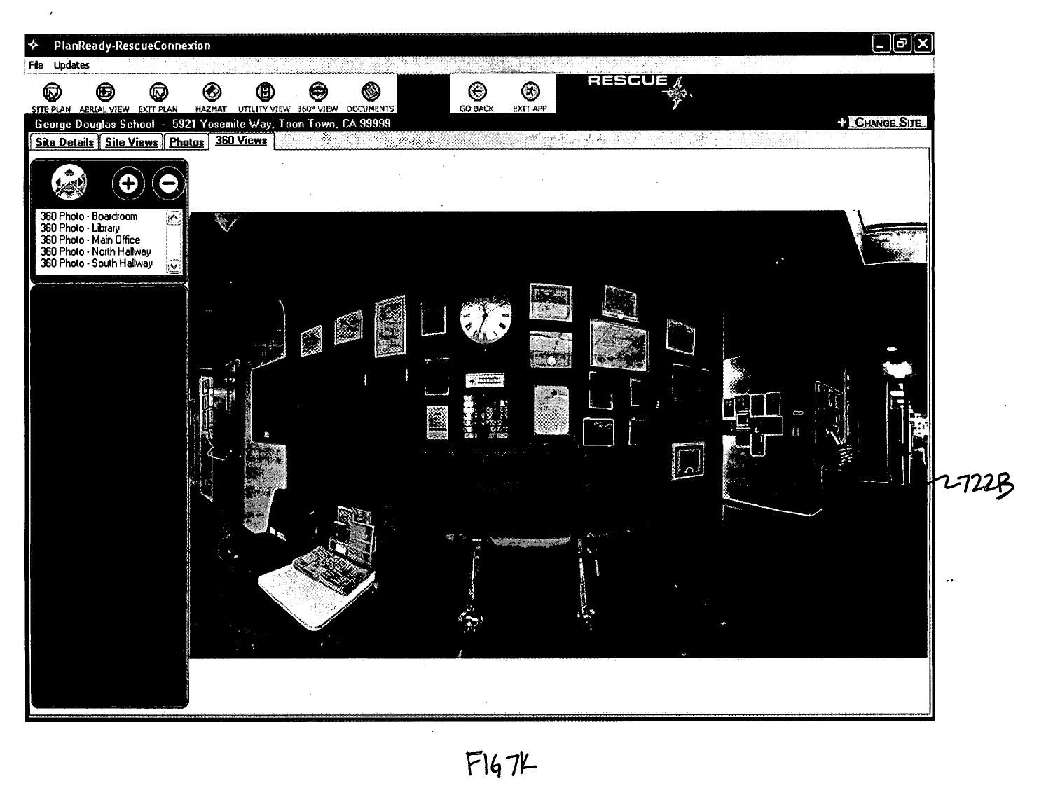

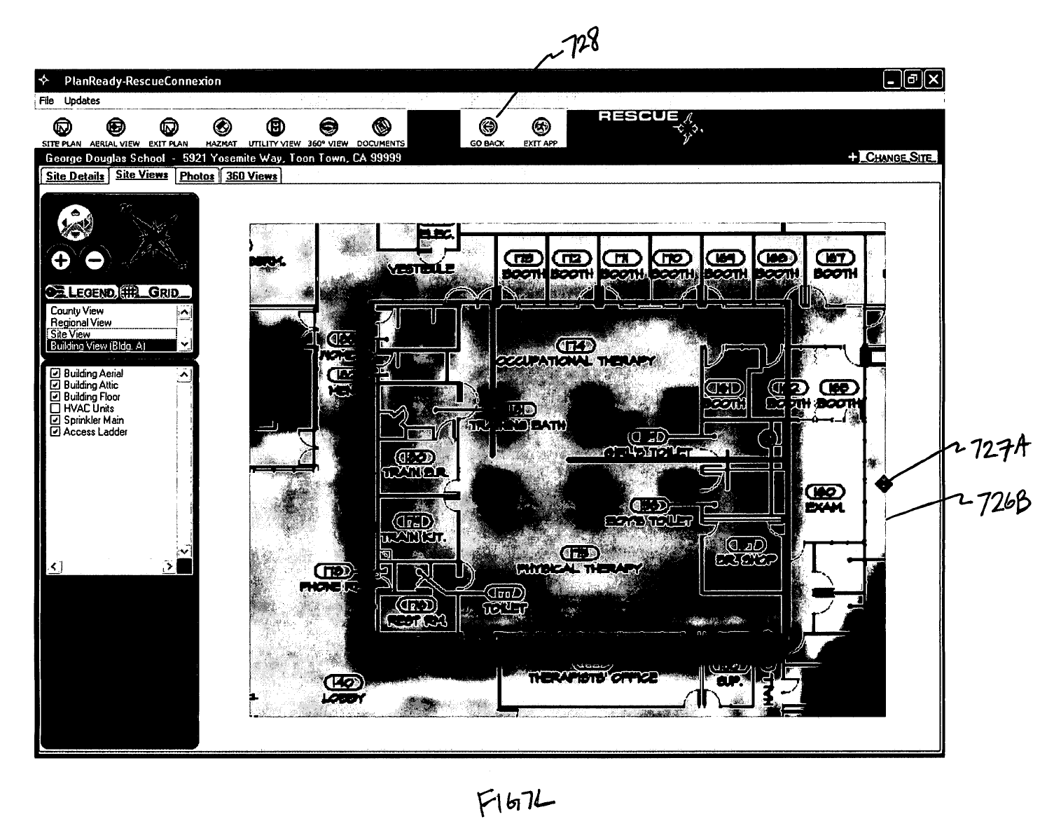

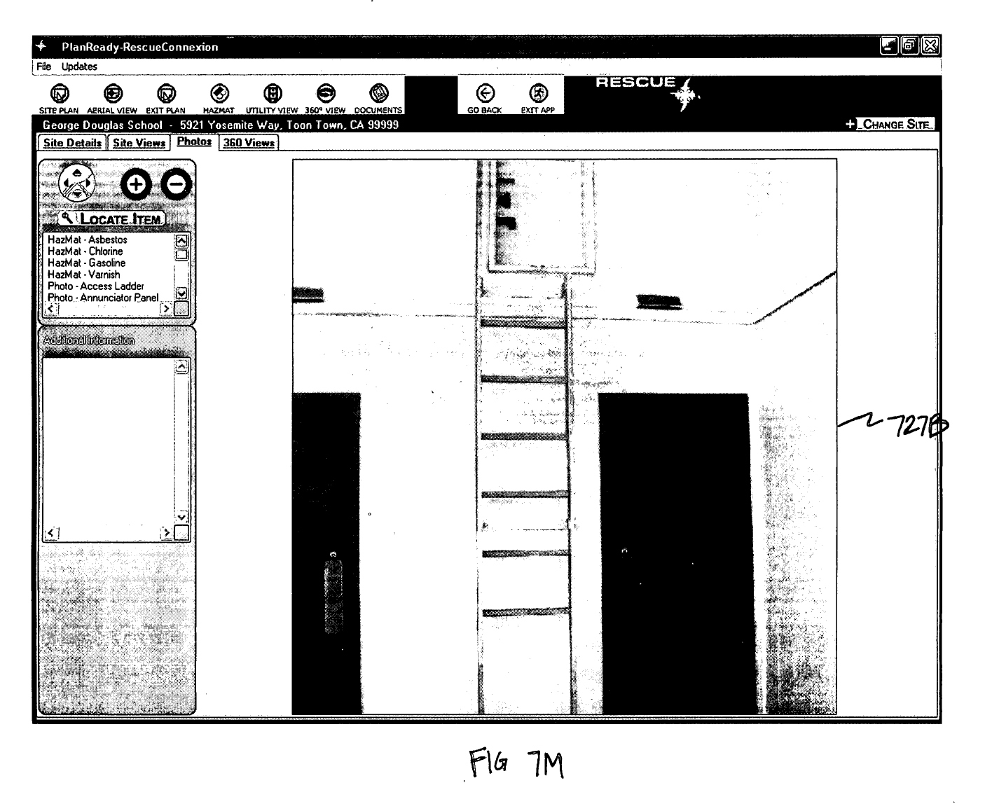

FIG. 7A is a screenshot showing another aerial view of the physical site shown in FIGS. 5A and 6A. In FIG. 7A, the aerial view is a site plan rather than an aerial photograph. This view allows a personnel member to more easily assess man-made structures when the information provided by an aerial photograph is unnecessary. In FIG. 7A, the site text layer listing 702A is selected, thereby indicating that site text 702B is overlaid on the site view.

In FIG. 7A, the site text includes, for example, “Therapy Room,” “Dining Room”, and “Office.” In certain embodiments, the site text shows actual room numbers and/or architectural room numbers. The site text allows for easier coordination of movement. For example, if the coordinated movement includes extraction of students from the therapy room during a school shooting crisis, a crisis coordinator may instruct an on-site personnel member, e.g. a SWAT team leader, to surround the therapy room. The site text allows the team leader to quickly assess the location of the therapy room and, using the grid, determine distances to the therapy room.

FIG. 7B is a screenshot showing the view of FIG. 7A with different layers overlaid on the view. In FIG. 7B, various utility layer listings 704A are selected. The utility layers 704B overlaid on the view each emphasize corresponding features of the physical site. For example, the gas shutoff layer emphasizes gas shutoffs and their location at the site. The electric shutoff layer emphasizes electric shutoffs and their location at the site. In certain applications, all the utility features of the site are emphasized by selecting utility view tool 704C.

The utility view tool 704C selects all layers relating to utilities, basically acting as a shortcut around individually selecting all the layers relating to utilities. In certain configurations, the utility view tool (or any one or more of the layer listings) is automatically selected when the member accesses a view, e.g. using default setting. This automatic selection, and therefore, automatic overlaying of one or more layers on a view, is based on a profile of the member provided with the view in certain configurations. For example, in one application, when a firefighter personnel member first views the site view, the fire alarm, sprinkler main, annunciator panel, and fire hydrant layers are automatically overlaid on the site plan based on the member's firefighter role. When a police officer member first views the site view, the indoor and outdoor staging area layers are automatically overlaid on the site plan based on the member's policing role.

FIG. 7C is a screenshot showing the view of FIG. 7B with additional layers overlaid on the view. As suggested above, each layer emphasizes a predetermined category of site features relevant to a role of the member provided with the view. A site feature may be, for example, a street, a fire lane, an emergency exit, a staging area, an escape route, a room, a utility shutoff, a fire hydrant, or hazardous material storage. In certain applications, a personnel member is able to select a site feature to view additional data about the feature. For example, a personnel member may select a room to view additional data about the room, e.g. the room's dimensions or seating capacity.

In certain applications, a personnel member selects a site feature by selecting an icon placed over or near the site feature. For example, in FIG. 7C, to view additional data about a hazardous material storage, the member selects icon 710A. Icon 710A links to a file containing the additional data about the corresponding hazardous material storage. In certain applications, an icon (e.g. the icon 710A) is positioned in a layer (e.g. a hazmat layer) by an authorized user who may or may not be a personnel member involved in the coordinated movement. For example, the authorized user may be an architect or a system administrator.

In FIG. 7C, icon 710A links to a photograph of the hazardous material storage. Selection of the icon displays on the user interface the photograph, as shown in FIG. 7D.

FIG. 7D is a screenshot showing the user interface of FIG. 7C after selection of an icon overlaid on the view. In FIG. 7D, the user interface displays a photograph 710B of the hazardous material storage. The photograph 710B allows personnel members to identify the hazardous material storage at the physical site quickly. In FIG. 7D, link 711A provides a link to another file providing more information relating to the site feature. Here, the file is a material safety data sheet (MSDS) relating to the hazardous material stored in the marked storage location. Selecting link 711A displays on the user interface the window shown in FIG. 7E.

FIG. 7E is a screenshot showing the user interface of FIG. 7D after selection of a link to a document. In FIG. 7E, a pop-up window lists the MSDS relating to the varnish stored at the site marked by icon 710A. The pop-up window also lists other MSDS files relating to other hazardous material stored in other hazardous material storage at the site. This allows a personnel member to access these other MSDS information if other hazardous material at the site is in actuality stored in this location as well.

In certain embodiments, when a member selects a link, the user interface also displays other information related to the subject matter of the link based on, for example, category of the subject matter, location of the subject matter, and/or role of the member. For example, if a firefighter selects a link associated with a sprinkler shutoff, the user interface may notify the firefighter that there is hazardous material near by, or that there is a HVAC unit above him (e.g. based on GPS information), or that there is a lake nearby. As another example, if the emergency involves an earthquake, the user interface may notify a coordinator of a lake on a nearby hill which may have dams or levees that may be broken.

FIG. 7F is a screenshot showing the user interface of FIG. 7C after selection of another icon overlaid on the view. In FIG. 7F, in response to selection of icon 712A, the user interface displays a photograph 712B of a sprinkler main. The photograph 712B allows personnel members to identify the sprinkler main at the physical site quickly. Additionally, the photograph 712B allows off-site personnel member, e.g. an expert consultant, to direct an on-site personnel member how to shut-off the sprinkler main, for example.

In certain applications, shut-off instructions are provided via a link to a file (similar to link 711A to the MSDS file). The file may be a document with text and/or diagrams. The file may also be a video, e.g. a video demonstration of how to shut off the sprinkler main, for example.

FIG. 7G is a screenshot showing the user interface of FIG. 7C after selection of yet another icon overlaid on the view. In FIG. 7G, the user interface displays a photograph 714B of an electrical shutoff after icon 714A was selected. In addition to the benefits discussed above, photograph 714B allows a personnel member to determine how much space surrounds the electrical shutoff. Using photograph 714B, a coordinator can determine that only one on-site personnel can access the electrical shutoff at a time, for example.

FIGS. 7H-7K are screenshots showing the user interface of FIG. 7C after selection of various icons overlaid on the view. In FIG. 7H, the user interface displays a photograph 716B of a gas shut-off after icon 716A was selected. In FIG. 7I, the user interface displays a photograph 718B of a fire alarm annunciator after icon 718A was selected. In FIG. 7J, the user interface displays a photograph 720B of a fire alarm panel after icon 720A was selected. In FIG. 7K, the user interface displays a photograph 722B showing a 360° view of the office room after icon 722B was selected.

FIG. 7L is a screenshot showing the user interface of FIG. 7C after a drill-down tool is selected. A drill-downed view 726B is displayed after drill-down tool 724A was selected. The drill-down tool 724A enables the member to select the site feature, here a building including the therapy room, to view additional data about the selected site feature. The drill-down tool may be used, in certain applications, to view successive floors in a multi-story building.

Like the previous (drilled-up) view, layers may be overlaid on the drill-downed view. In FIG. 7L, an access ladder layer listing is selected, thereby overlaying icon 727A on the drilled-down view. Selection of icon 727A displays on the user interface a photograph 727B shown in FIG. 7M.

FIG. 7M is a screenshot showing the user interface of FIG. 7L after selection of an icon overlaid on a drilled-down view. Accordingly, the icons and tools overlaid on the drilled-up view (i.e. the site plan shown in FIG. 7C) may also be overlaid on the drilled-down view. This allows the personnel member to drill down even further to view even more data about a particular region of the drilled-down view 726B. The personnel member is also able to drill-up to view decreasingly detailed data about the selected site feature using a drill-up tool, e.g. tool 728.

As can be understood from FIGS. 7A-7M and the related discussion, additional data about a selected feature, viewed after selection of an icon or drill-down tool, may be in the form of a photograph pre-recorded video, detailed drawing, detailed map, architectural plan, shut-off instructions, or handling instructions. In addition, the additional data may be in the form of a live video feed (e.g. from a security camera at the site), a description of the location of the feature, operating instructions, removal instructions, and contact information for an organization associated with the feature.

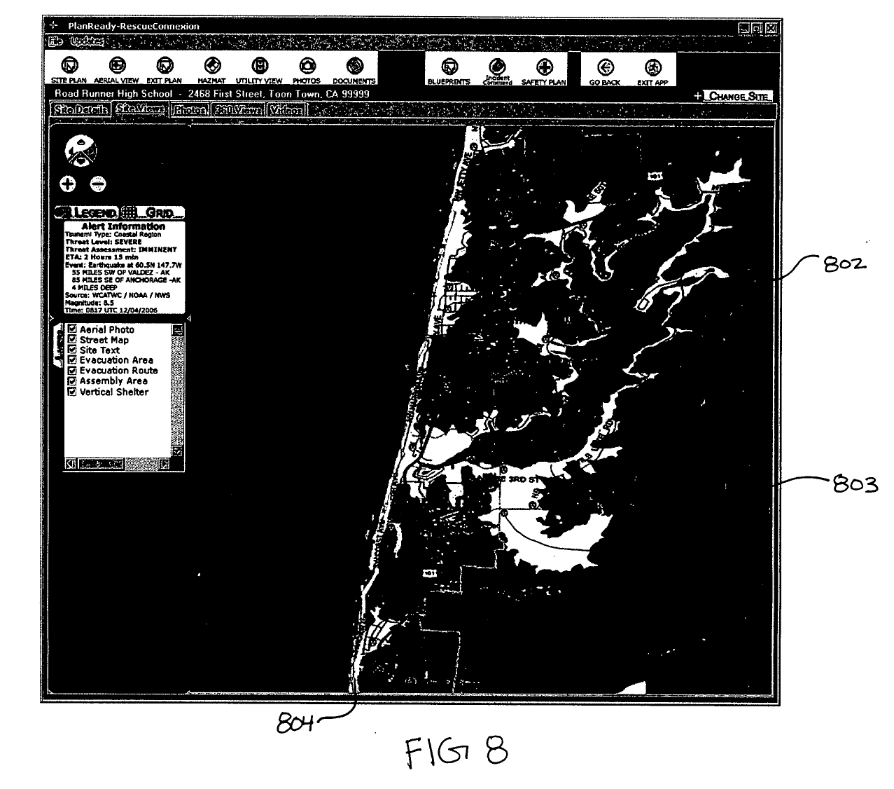

FIG. 8 is a screenshot showing a user interface when one embodiment of this invention is applied to a coordinated movement associated with a tsunami, e.g. an evacuation plan for or during a tsunami.

For a tsunami, two types of coordinated movements are particularly relevant: a horizontal evacuation and a vertical evacuation. A horizontal evacuation primarily involves moving people (and/or animals) across the surface of the earth, e.g. using roads. A vertical evacuation primarily involves moving people (and/or animals) vertically, e.g. into higher levels of sturdy buildings. For a particular tsunami event, a combination of horizontal and vertical evacuations may be involved, depending on how much amount of time is available for evacuation (e.g. how early is a warning is received) and how much amount of time a certain evacuation would take (e.g. number of people, paved roads v. unpaved road, available transportation).

For example, if a tsunami forms close to ocean cities, little time may be available for a horizontal evacuation using regular roads. The roads may become quickly congested before most people reach a safe distance from the coast or higher ground. In such a scenario, a vertical evacuation may be used to gather people in sturdy high-rise buildings that can be designated as safe havens. These high rise buildings may be marked (such as with arrows 802 or green dots 803, for example) on the aerial view of the region shown in the user interface of FIG. 8.

In one embodiment, a server, e.g. the server 114, is connected to an early warning system, e.g. an international or regional tsunami warning system. Warning information may then be transmitted to the clients connected to the server. Additionally, based on the warning information, a system in one embodiment of the present invention may use that information to calculate a projected time and impact (e.g. based on speed, ocean depth, etc.) and translate the information into a readily understandable form, e.g. marking high impact areas, as shown in FIG. 8 by yellow regions 804. In one embodiment, the impact regions are shown as multiple layers categorized by expected severity of impact. Each layer may then be overlaid separately on the aerial view. In certain embodiments, based on this information, a system of the present invention (e.g. the server 114) may also calculate alternative evacuation routes, and transmit these routes to connected clients.

Thus, a system and method for coordinating movement of personnel is disclosed. Although the present invention is described herein with reference to a specific preferred embodiment, many modifications and variations therein will readily occur to those with ordinary skill in the art, including application of this invention to movements not described in detail herein.

It shall also be appreciated that a single portable device may act as both a portable device 104 and a client device 106 as described herein. The single device includes storage (e.g. a hard drive, RAM, or ROM), a processor, and a display. The single device maybe, for example, a portable computer, an iPod®, a personal digital assistant, a multi-media mobile phone, etc. The single portable device stores the information that, in other embodiments, is stored in a portable device 104 and allows a user to view the information that a user, in other embodiments, is viewed on a display of a client device 106. When the single device connects to a network (e.g. 108), the single device then behaves as a combined portable device and client device would behave when connected to the network.

Accordingly, all such variations and modifications are included within the intended scope of the present invention as defined by the following claims.

What is claimed is:

1. A method for coordinating movement of emergency personnel comprising:
providing an aerial view of a physical site to an emergency personnel member, the aerial view accessible to a plurality of emergency personnel members each having an assigned role;
enabling overlaying of one or more layers on the view, each layer emphasizing a predetermined category of site features relevant to a role of the member provided with the view; and
providing a tool enabling the member to select a site feature emphasized in an overlaid layer to view additional data about the selected site feature.

2. The method of claim 1, further comprising:
overlaying a grid on the view indicating physical distances at the site.

3. The method of claim 1, further comprising:
automatically overlaying one of the layers on the view based on a profile of the member provided with the view.

4. The method of claim 1, wherein
the selected site feature is selected from the group consisting of: a street, a fire lane, an emergency exit, a staging area, an escape route, and a room; and
the additional data is selected from the group consisting of: a photo, a pre-recorded video, a live video feed, a detailed drawing, a detailed map, and an architectural plan.

5. The method of claim 1, wherein
the selected site feature is selected from the group consisting of: a utility shutoff, a fire hydrant, and hazardous material storage; and
the additional data is selected from the group consisting of: a description of a location of the feature, operating instructions, shut-off instructions, removal instructions, handling instructions, a photo of the feature, a video of the location of the feature, and contact information for an organization associated with the feature.

6. The method of claim 1, wherein the tool includes an icon positioned in the overlaid layer by an authorized user, the icon linking to a file containing the additional data to be displayed in another overlaid layer when the icon is selected.

7. The method of claim 1, wherein the tool includes a drill-down tool and a drill-up tool, the drill-down tool enabling the member to view increasingly detailed data about the selected site feature and the drill-up tool enabling the member to view decreasingly detailed data about the selected site feature.

8. A method for coordinating movement of personnel comprising:
transmitting an aerial view of a physical site to a plurality of displays, the plurality of displays viewed by a plurality of respective personnel members, each having an assigned role;
enabling overlaying on the aerial view of one or more layers emphasizing features of the site relevant to the currently coordinated movement, including a first layer indicating locations of people at the physical site;
enabling a first member having a first role to add to one of the layers an icon indicating a location of a person or an object at the site;
enabling the first member to link information to the icon; and
in response to a signal indicating a second member selected the icon, the second member having a second role authorized to view the linked information, transmitting the linked information to a display viewed by the second member.

9. The method of claim 8, wherein the linked information is selected from the group consisting of: a photo, a detailed map, a detailed plan, and a video.

10. The method of claim 8, wherein the locations of the people are anticipated locations based on independently obtained data.

11. The method of claim 8, further comprising:
determining the locations of the people at the site based on real-time data.

12. The method of claim 11, further comprising:
receiving the real-time data from one or more transmitters carried by personnel at the site.

13. A user interface for coordinating movement of human personnel comprising:
a plurality of views of a physical site of a coordinated movement, each view viewable by personnel members based on roles of respective members;
a plurality of icons each associated with a predefined scenario; and
a selector enabling at least one of the personnel members to select at least one of the icons to trigger transmission of directions to at least one other personnel member to direct the at least one other personnel member to perform a predetermined action at the physical site based on the scenario associated with the icon.

14. The interface of claim 13, further comprising:
a collaboration tool enabling a first personnel member viewing the user interface on a first display to communicate in real-time with at least one a second personnel member viewing the user interface on at least one other display.

15. The interface of claim 13, further comprising:
a shortcut to one of the views, the shortcut viewable based on the roles.

16. A portable device for providing information relevant to a coordinated personnel movement at a physical site comprising:
a hardware identifier;
an output interface to communicate with a client device;
local memory storing a version of the information based on a role of a personnel member assigned to the portable device, the information including an aerial view of the physical site;
local memory access to provide access to the version independent of network connections; and
network connection access to communicate, securely using the hardware identifier, with a server to update the version of the information stored in the local memory when the client device has a network connection.

17. The device of claim 16, further comprising:
a global positioning system (GPS) transceiver; and
a GPS display to display a location of the GPS transceiver on the aerial view.

18. The device of claim 16, wherein the information stored in the memory includes voice or video directions on operating the device.

19. A system for coordinating movement of personnel comprising:
a network interface to communicate to a plurality of portable devices via one or more client devices, each portable device connectable to each of the one or more client devices and operated by a personnel member at a physical site of a coordinated movement;
storage to store information relating to the physical site, including a plurality of views of the site, wherein at least one view is overlayable on another view to emphasize a feature of the site relevant to the coordinated movement;
a server, connected to the network interface and to the storage, to provide role-based access to the information and update versions of the information stored on respective portable devices when a client device to which a respective portable device is connected has network access to the server.

20. The system of claim 19, further comprising:
an emergency system interface to transmit a command to an emergency device in an emergency system at the physical site, the emergency device selected from the group consisting of: an emergency exit sign, an emergency exit direction light, a security camera, a fire door, and a fire sprinkler.

21. The system of claim 19, wherein the server includes a collaborator to enable personnel members to communicate in real-time, including a force collaborator module to force a specific view to be displayed simultaneously on each client device having network access to the server and running an executable stored on the respective connected portable device.

22. The system of claim 19, wherein the server includes a collaborator to enable personnel members to communicate in real-time, the collaborator including at least one selected from the group consisting of: an instant messenger device, a white board device, a chat device, a video conferencing device, a phone conferencing device, and a collaborative log book.

23. The system of claim 19, wherein the server includes a security module to secure the information stored in the storage from unauthorized access and to authorize transfer of at least a subset of the information to one of the portable devices based on a respective hardware identifier.

24. An apparatus comprising:
a portable system for providing a view of a physical site to a user; and
a plurality of selection icons to enable the user to select an overlay over the view, the overlay providing emergency-relevant data regarding the physical site.

25. The apparatus of claim 24, wherein the emergency-relevant data comprises one or more of the following: fire-relevant data, flood-relevant data, medical emergency relevant data, escape routes, and a hazardous waste location.

26. The apparatus of claim 25, wherein a subset of the icons are selectable by the user based on the user's role.
